(19) United States
(12) Patent Application Publication
(10) Pub. No.: US 2016/0012560 A1
(43) Pub. Date: Jan. 14, 2016

(54) SYSTEM AND METHOD FOR EMERGENCY PLANNING MANAGEMENT

(71) Applicants: Michael L. Johnson, Fort Lauderdale, FL (US); Scott S. Tholan, Potomac, MD (US)

(72) Inventors: Michael L. Johnson, Fort Lauderdale, FL (US); Scott S. Tholan, Potomac, MD (US)

(21) Appl. No.: 14/794,348

(22) Filed: Jul. 8, 2015

Related U.S. Application Data
(60) Provisional application No. 62/021,802, filed on Jul. 8, 2014.

(51) Int. Cl. G06Q 50/26; H04L 29/08

(52) U.S. Cl. CPC G06Q 50/265; H04L 67/306

(57) ABSTRACT

A method of providing an emergency or crisis plan to a user is disclosed that includes receiving a plurality of user-inputted answers associated with a user-identified account and corresponding to a plurality of questions concerning at least one of a potential threat, a potential hazard, and a potential vulnerability associated with the user. A server system assigns a weighted value to each of the plurality of user-inputted answers and provides, to the electronic computing device of the user, a plurality of response protocols, each of the plurality of response protocols corresponding to an action to be taken by the user in response to the potential threat, hazard, and/or vulnerability of the user. The plurality of user-inputted answers are converted into an assessment matrix that ranks the potential threat, hazard, and/or vulnerability.

### CROSS-REFERENCE TO RELATED APPLICATION

This application claims priority to U.S. Provisional Patent Application No. 62/021,802 filed Jul. 8, 2014, the entirety of which is incorporated by reference.

### FIELD OF THE INVENTION

The present invention relates generally to emergency planning management, and, more particularly, relates to a system and method for generating distinct emergency response protocols tailored to individual circumstances.

### BACKGROUND OF THE INVENTION

It is well known that schools, communities, families, and the like, are often ill-prepared for emergency situations. Ill-preparation can lead to property loss, bodily injury, and mortality, which may have otherwise been avoided through proper emergency planning.

Systems and methods that aid in emergency planning have been developed. For example, some existing systems allow family members to develop a family disaster plan tailored to the demographic and geographic information provided by a user. Such systems may include a database and communications server that prompts questions and/or discloses information to the user particular to the user's demographic and geographic location. Other systems allow users to input information into a system to develop an emergency response plan tailored to the types of emergencies the user might encounter. The emergency response plan, however, is often limited to a residential setting, taking into account only information pertinent to the user's residential information, location of residence, and details surrounding the occupants of the residence. Unfortunately, these systems do not allow the user to provide answers that are thereafter weighted in order to develop unique response protocols based on a ranking of the emergency situation. Further, many systems also do not enable the user to maintain and print a printable crisis management sheet displaying said unique response protocols for use when a crisis does occur and Internet access is unavailable or multiple individuals need guidance on the proper response protocol.

Other known systems and methods provide users with suggested protocols for dealing with emergency events at the time the event occurs. Such systems may generate and provide a mathematically optimal set of decisions to one or more decision makers during chaotic events. Such systems do not allow the user to prepare for the emergency event prior to the event itself, which may mitigate the amount of damage caused by the emergency event and increase the crisis manager's response time to a particular crisis, which is undesirable and potentially life threating for many individuals and entities in need of such systems.

At least one additional known system allows users to create, maintain, and distribute relevant crisis response information for specific types of emergencies. Upon being presented with a specific screen interface, the user is given a choice of pre-specified crisis plan templates with which to produce the response plan for the specified incident. The response plans generated by the system include predetermined response scripts, texts, tasks, materials, methodologies, objectives, and/or evaluation criteria. Unfortunately, such system does not provide the user with the ability to tailor the response plan to the user's individual situation. In the same vein, the system does not afford the user with the ability to provide answers that are thereafter weighted in order to develop a unique response protocol based on the ranking of the emergency situation.

Therefore, a need exists to overcome the problems with the prior art as discussed above.

### SUMMARY OF THE INVENTION

The invention provides a system and method for emergency planning management that overcomes the hereinafore-mentioned disadvantages of the heretofore-known devices and methods of this general type.

With the foregoing and other objects in view, there is provided, in accordance with the invention, a computer-implemented method of providing an emergency or crisis plan to a user that includes receiving a plurality of user-inputted answers, from an electronic computing, e.g., having a processor, device of a user, at a server system communicatively coupled to the electronic computing device of the user, wherein the plurality of user-inputted answers are associated with a user-identified account and are corresponding to a plurality of questions concerning either a potential threat, a potential hazard, and/or a potential vulnerability associated with the user. The method also includes assigning, by the server system, a weighted value to each of the plurality of user-inputted answers, then converting, with a processor associated with the server system, the plurality of user-inputted answers into an assessment matrix that ranks the at least one of the potential threat, the potential hazard, and the potential vulnerability associated with the user. The assessment matrix associates the potential threat, the potential hazard, and/or the potential vulnerability with either a plurality of response protocols and/or a corresponding threat ranking, wherein the threat ranking based on at least one of the weighted values assigned to the each of the plurality of user-inputted answers. The method also includes electronically communicating, through the server system, to the electronic computing device of the user, the plurality of response protocols, each corresponding to an action to be taken by the user in response to the potential threat, the potential hazard, and/or the potential vulnerability of the user. The process then includes electronically communicating, through the server system, to the electronic computing device of the user, a computer-printable quick action guide depicting the at least one of the plurality of response protocols.

In accordance with another feature, an embodiment of the present invention may also include (1) receiving, from the electronic computing device of the user, at least one user-selected color, (2) receiving, from the electronic computing device of the user, a selection of one of the plurality of response protocols to be associated with the at least one user-selected color, (3) associating, with the processor associated with the server system, the at least one user-selected color with the selection of the one of the plurality of response protocols, and/or (4) printing the computer-printable quick action guide such that the at least one user-selected color visually corresponds to the selection of the one of the plurality of response protocols depicted in the computer-printable quick action guide.

In accordance with yet another feature, an embodiment of the present invention may also include receiving a selection of at least one of the plurality of response protocols, from the electronic computing device of the user, at the server system communicatively coupled to the electronic computing device of the user.

In accordance with an additional feature, an embodiment of the present invention may include providing the plurality of response protocols as a result of the weighted value assigned to at least one of the plurality of user-inputted answers exceeding a predetermined threshold value. The predetermined threshold value may be of a non-zero threshold value.

In accordance with another feature, an embodiment of the present invention may include receiving a user-created response protocol, from the electronic computing device of the user, at the server system and/or then associating, by the server system, the user-created response protocol received from the electronic computing device of the user with the at least one of the potential threat, the potential hazard and the potential vulnerability.

In accordance with yet another feature, an embodiment of the present invention may also include providing, by the server system, to the electronic computing device of the user, at least one of the plurality of questions based on one of the plurality of user-inputted answers to a previous one of the plurality of questions. Further, the method may also include providing, by the server system, an emergency planning management dashboard associated with the user-identified account to the electronic computing device of the user. The emergency planning management dashboard is operable to accept an input from a user input interface communicatively coupled to the electronic computing device of the user, send the input to the server system to be stored on a remote database associated with the server system, and then present information in real-time on the electronic computing device of the user based on the input, wherein the information accessible by the user via the electronic computing device of the user as a result of the user logging-in to the user-identified account.

In accordance with a further feature of the present invention, a gauge may be presented on at least a portion of the emergency planning management dashboard, wherein the gauge defines a graphical, computer-displayable visual depiction of a user's emergency planning management preparedness level, the user's emergency planning management preparedness level based on the input to the server system.

In accordance with an additional feature of the present invention, the user-identified account is operably configured to be associated with a plurality of users and at least a portion of the plurality of users are assigned to a role within a crisis management team associated with the user-identified account.

In accordance with the present invention, a system for providing an emergency or crisis plan to a user is disclosed that includes, at least one network connection communicatively coupled to at least one electronic computing device of a user and at least one processor communicatively coupled to the at least one network connection. The at least one processor is operable to execute a set of computer instructions for (1) receiving a plurality of user-inputted answers, over the at least one network connection, from the electronic computing device of the user, wherein the plurality of user-inputted answers are associated with a user-identified account and correspond to a plurality of questions concerning either a potential threat, a potential hazard, and/or a potential vulnerability associated with the user; (2) assigning a weighted value to each of the plurality of user-inputted answers; (3) converting the plurality of user-inputted answers into an assessment matrix that ranks the potential threat, the potential hazard, and/or the potential vulnerability associated with the user, wherein the assessment matrix associating the potential threat, the potential hazard, and/or the potential vulnerability with either the plurality of response protocols and/or a corresponding threat ranking, with the threat ranking based on the weighted value assigned to at least one of the plurality of user-inputted answers; (4) electronically communicating, over the at least one network connection, to the electronic computing device of the user, a plurality of response protocols, each of the plurality of response protocols corresponding to an action to be taken by the user in response to the at least one of a potential threat, a potential hazard, and a potential vulnerability of the user; and (5) electronically communicating, through the server system, to the electronic computing device of the user, a computer-printable quick action guide depicting the at least one of the plurality of response protocols.

Although the invention is illustrated and described herein as embodied in a system and method for emergency planning management, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention. Any text depicted in the below figures which falls below 0.32 cm is not being relied upon, as used in said figure, by applicants to form a part of the present invention.

FIG. 1 is a block diagram of an exemplary distributed data processing network with an server system, and an electronic device in accordance with an embodiment of the present invention;

FIG. 2 is a block diagram of a data processing system that may be implemented as a network device, such as the electronic device shown in FIG. 1, in accordance with an embodiment of the present invention;

FIG. 3a is a process flow chart representing an exemplary method of conducting a providing an emergency or crisis plan to a user over a network in accordance with the present invention;

FIG. 3b is a continuation flow chart of the exemplary process shown in FIG. 3a, in accordance with the present invention;

FIG. 4 is a screenshot of an exemplary software application at least partially implementing the inventive process, the screenshot depicting a home screen on a user's electronic mobile device in accordance with an embodiment of the present invention;

FIG. 5 is a screenshot from the exemplary software application of FIG. 4 depicting a gauge element in accordance with an embodiment of the present invention;

FIG. 6 is screenshot from the exemplary software application of FIG. 4 depicting a set-up wizard in accordance with an embodiment of the present invention;

FIG. 7 is screenshot from the exemplary software application of FIG. 4 depicting an owner profile in accordance with an embodiment of the present invention;

FIG. 8 is screenshot from the exemplary software application of FIG. 4 depicting a delegation of authority in accordance with an embodiment of the present invention;

FIG. 9 is screenshot from the exemplary software application of FIG. 4 depicting a delegation of authority document dialogue box in accordance with an embodiment of the present invention;

FIG. 10 is screenshot from the exemplary software application of FIG. 4 depicting a plurality of sub-categories in a settings view in accordance with an embodiment of the present invention;

FIG. 11 is screenshot from the exemplary software application of FIG. 4 depicting calendar section in accordance with an embodiment of the present invention;

FIG. 12 is screenshot from the exemplary software application of FIG. 4 depicting a calendar event pop-up interface in accordance with an embodiment of the present invention;

FIG. 13 is screenshot from the exemplary software application of FIG. 4 depicting a prompt explaining the location toggle bar in accordance with an embodiment of the present invention;

FIG. 14 is screenshot from the exemplary software application of FIG. 4 depicting a school location section in accordance with an embodiment of the present invention;

FIG. 15 is screenshot from the exemplary software application of FIG. 4 depicting school location information in accordance with an embodiment of the present invention;

FIG. 16 is screenshot from the exemplary software application of FIG. 4 depicting an add location dialogue box in accordance with an embodiment of the present invention;

FIG. 17 is screenshot from the exemplary software application of FIG. 4 depicting a grade configuration section in accordance with an embodiment of the present invention;

FIG. 18 is screenshot from the exemplary software application of FIG. 4 depicting a list of account users in accordance with an embodiment of the present invention;

FIG. 19 is screenshot from the exemplary software application of FIG. 4 depicting a “create a new user” button in accordance with an embodiment of the present invention;

FIG. 20 is screenshot from the exemplary software application of FIG. 4 depicting a system activity section in accordance with an embodiment of the present invention;

FIG. 21 is screenshot from the exemplary software application of FIG. 4 depicting a payment information page in accordance with an embodiment of the present invention;

FIG. 22 is screenshot from the exemplary software application of FIG. 4 depicting a recycle bin in accordance with an embodiment of the present invention;

FIG. 23 is screenshot from the exemplary software application of FIG. 4 depicting an open items view portion associated with the settings in accordance with an embodiment of the present invention;

FIG. 24 is screenshot from the exemplary software application of FIG. 4 depicting an open items view portion associated with the main dashboard in accordance with an embodiment of the present invention;

FIG. 25 is screenshot from the exemplary software application of FIG. 4 depicting a self-assessment section in accordance with an embodiment of the present invention;

FIG. 26 is screenshot from the exemplary software application of FIG. 4 depicting a threat assessment in accordance with an embodiment of the present invention;

FIG. 27 is screenshot from the exemplary software application of FIG. 4 depicting an exemplary question in accordance with an embodiment of the present invention;

FIG. 28 is screenshot from the exemplary software application of FIG. 4 depicting another exemplary question in accordance with an embodiment of the present invention;

FIG. 29 is screenshot from the exemplary software application of FIG. 4 depicting a drop down menu of a plurality of response protocols in accordance with an embodiment of the present invention;

FIG. 30 is screenshot from the exemplary software application of FIG. 4 depicting a user-created defined scenario dialogue box in accordance with an embodiment of the present invention;

FIG. 31 is screenshot from the exemplary software application of FIG. 4 depicting a vulnerabilities section in accordance with an embodiment of the present invention;

FIG. 32 is screenshot from the exemplary software application of FIG. 4 depicting an exemplary question in the vulnerabilities section in accordance with an embodiment of the present invention;

FIG. 33 is screenshot from the exemplary software application of FIG. 4 depicting another exemplary question in the vulnerabilities section in accordance with an embodiment of the present invention;

FIGS. 34-36 are screenshots from the exemplary software application of FIG. 4 depicting portions of an assessment matrix in accordance with an embodiment of the present invention;

FIG. 37 is screenshot from the exemplary software application of FIG. 4 depicting a response planning menu in accordance with an embodiment of the present invention;

FIG. 38 is screenshot from the exemplary software application of FIG. 4 depicting a crisis management team section in accordance with an embodiment of the present invention;

FIG. 39 is screenshot from the exemplary software application of FIG. 4 depicting a crisis management team in accordance with an embodiment of the present invention;

FIG. 40 is screenshot from the exemplary software application of FIG. 4 depicting a dialogue box for the crisis management team in accordance with an embodiment of the present invention;

FIG. 41 is screenshot from the exemplary software application of FIG. 4 depicting a fill position dialogue box in accordance with an embodiment of the present invention;

FIG. 42 is screenshot from the exemplary software application of FIG. 4 depicting a rally points section in accordance with an embodiment of the present invention;

FIG. 43 is screenshot from the exemplary software application of FIG. 4 depicting a list of all the rally points input by the user in accordance with an embodiment of the present invention;

FIG. 44 is screenshot from the exemplary software application of FIG. 4 depicting an “add rally point” dialogue box in accordance with an embodiment of the present invention;

FIG. 45 is screenshot from the exemplary software application of FIG. 4 depicting response protocols section in accordance with an embodiment of the present invention;

FIG. 46 is screenshot from the exemplary software application of FIG. 4 depicting edit response protocol dialogue box in accordance with an embodiment of the present invention;

FIG. 47 is screenshot from the exemplary software application of FIG. 4 depicting an add protocol dialogue box in accordance with an embodiment of the present invention;

FIG. 48 is screenshot from the exemplary software application of FIG. 4 depicting a drop down menu of rally points in accordance with an embodiment of the present invention;

FIG. 49 is screenshot from the exemplary software application of FIG. 4 depicting a drop down menu for color section in accordance with an embodiment of the present invention;

FIG. 50 is screenshot from the exemplary software application of FIG. 4 depicting a step by step instruction guide for creating a quick action guide in accordance with an embodiment of the present invention;

FIG. 51 is screenshot from the exemplary software application of FIG. 4 depicting a physical quick action guide booklet in accordance with an embodiment of the present invention;

FIG. 52 is screenshot from the exemplary software application of FIG. 4 depicting a list of local resources in accordance with an embodiment of the present invention;

FIG. 53 is screenshot from the exemplary software application of FIG. 4 depicting an “add resource” dialogue box in accordance with an embodiment of the present invention;

FIG. 54 is screenshot from the exemplary software application of FIG. 4 depicting an “edit resource” dialogue box in accordance with an embodiment of the present invention;

FIG. 55 is screenshot from the exemplary software application of FIG. 4 depicting an in-school (or on-location) resources section in accordance with an embodiment of the present invention;

FIG. 56 is screenshot from the exemplary software application of FIG. 4 depicting an “add resource” dialogue box in accordance with an embodiment of the present invention;

FIG. 57 is screenshot from the exemplary software application of FIG. 4 depicting a medical equipment section in accordance with an embodiment of the present invention;

FIG. 58 is screenshot from the exemplary software application of FIG. 4 depicting an emergency equipment section in accordance with an embodiment of the present invention;

FIG. 59 is screenshot from the exemplary software application of FIG. 4 depicting a training section in accordance with an embodiment of the present invention;

FIG. 60 is screenshot from the exemplary software application of FIG. 4 depicting a managing training types section in accordance with an embodiment of the present invention;

FIG. 61 is screenshot from the exemplary software application of FIG. 4 depicting an “add training” dialogue box in accordance with an embodiment of the present invention;

FIG. 62 is screenshot from the exemplary software application of FIG. 4 depicting a “log training” dialogue box in accordance with an embodiment of the present invention;

FIG. 63 is screenshot from the exemplary software application of FIG. 4 depicting a drills section in accordance with an embodiment of the present invention;

FIG. 64 is screenshot from the exemplary software application of FIG. 4 depicting a managing drill types section in accordance with an embodiment of the present invention;

FIG. 65 is screenshot from the exemplary software application of FIG. 4 depicting an “add drill” dialogue box in accordance with an embodiment of the present invention;

FIG. 66 is screenshot from the exemplary software application of FIG. 4 depicting a “log drill” dialogue box in accordance with an embodiment of the present invention;

FIG. 67 is screenshot from the exemplary software application of FIG. 4 depicting an incidents section in accordance with an embodiment of the present invention;

FIG. 68 is screenshot from the exemplary software application of FIG. 4 depicting a manage incident type section in accordance with an embodiment of the present invention;

FIG. 69 is screenshot from the exemplary software application of FIG. 4 depicting an add incidents section in accordance with an embodiment of the present invention;

FIG. 70 is screenshot from the exemplary software application of FIG. 4 depicting a log incidents section in accordance with an embodiment of the present invention;

FIGS. 71-73 are screenshots from the exemplary software application of FIG. 4 depicting stakeholder sections in accordance with an embodiment of the present invention;

FIG. 74 is screenshot from the exemplary software application of FIG. 4 depicting a photographs section in accordance with an embodiment of the present invention;

FIG. 75 is screenshot from the exemplary software application of FIG. 4 depicting another documents section in accordance with an embodiment of the present invention;

FIG. 76 is screenshot from the exemplary software application of FIG. 4 depicting an uploaded documents section in accordance with an embodiment of the present invention;

FIG. 77 is screenshot from the exemplary software application of FIG. 4 depicting a reference library section in accordance with an embodiment of the present invention; and

FIG. 78 is screenshot from the exemplary software application of FIG. 4 depicting at least two print options in accordance with an embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

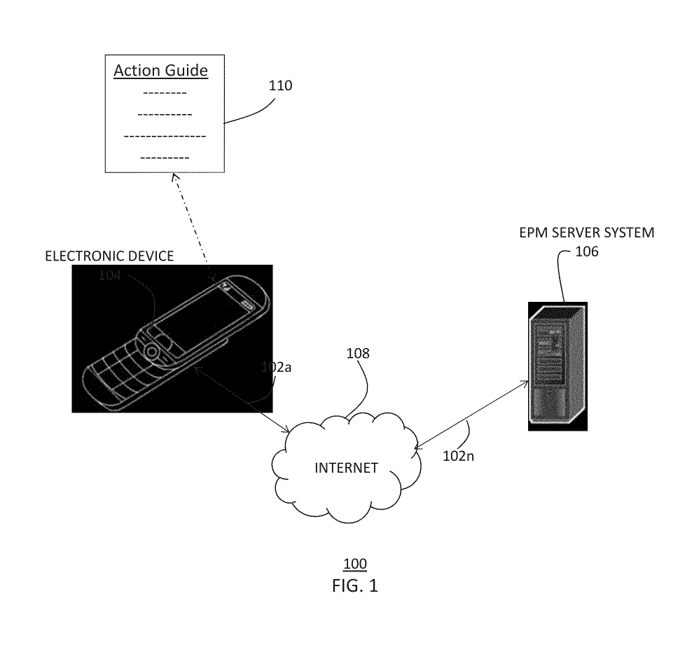

The present invention provides a novel and efficient emergency and crisis management tool that overcomes many disadvantages found within those known devices and methods of providing emergency and crisis plans by effectively utilizing weighted user-inputted data and providing protocols tailored for each individual user for use by the user after an emergency situation arises. Embodiments of the invention provide an inventive assessment matrix that ranks potential threats, hazards, or vulnerabilities of the user, the threat ranking being based on the weighted user-inputted data. In addition, embodiments of the invention provide an EPM Dashboard (“Dashboard”) implemented as a web-based tool designed to allow users to create, manage and store their emergency and crisis management plans in the “cloud,” or a remote server, yet communicatively coupled with, an electronic device of the user. The term “EPM” is defined as emergency planning management, but shall not be limited to only emergencies. Said another way, EPM shall refer to any unforeseen or projected combination of circumstances resulting in a state that calls for immediate action, or an urgent need for assistance or relief With reference to FIG. 1, in one embodiment, as a cloud tool, user's information resides on one or more remote servers systems 106 (operated by a party/entity other than the user), where as part of the subscription fee, said party/entity is responsible for the system maintenance and upkeep.

The Dashboard guides users (also referred to herein as “clients”) in the creation of an emergency or crisis response plan that is focused on a user's self-assessment of threats and hazards. The principle behind the Dashboard design is that crisis planning is more than just having a printed plan and puts the emphasis on practicing how the user's stakeholders respond to the crises or emergencies they may face.

Users of the software can create an account, add additional users, change their user information, etc. However, specific to the application of emergency planning management, the platform has several additional unique features that are described in more detail herein below. In some embodiments, those features are further tailored/customized to the entity or user being supported, i.e., international schools, international businesses, non-governmental organizations, etc. A non-exhaustive list of those unique features includes (1) a gas gauge, (2) a wizard, (3) a self-assessment, (4) an assessment matrix, and (5) response planning.

The “gas gauge” (as shown in FIG. 5) is a graphical icon designed to visually display the overall “preparedness” of a client's account and the ongoing progress they are making in their emergency and crisis management activities.

The “wizard” is a feature designed to guide a user or users through the process of populating their account step-by-step.

The “self-assessment” is a series of questions—created generally by a party other than the user—that the user must complete as part of the account configuration. The questions are arranged in a parent-child configuration where child questions are grouped by broad parent categories. For example, “Heat Waves” and “Pollution” are child questions belonging to the category “Nature.” Wherein “Nature” is the parent to related threat and hazard child questions. The self-assessment is broken down into:
a) Threats and Hazards
b) Vulnerabilities
   1. Both sections feed their results into an “assessment matrix”

The “assessment matrix” is a graphical icon or interface where results from the self-assessment are fed into and where account user(s) and administrator(s) can review client's answers, sort and prioritize threats, and then provide feedback based on the client's answers.

“Response planning” is a section where the user can build their crisis management team, identify and enter rally points, establish response protocols, store emergency contacts, and manage related emergency equipment.
c) Crisis Management Team (CMT)—An organizational chart identifying key roles to be played by the institutions' management team wherein the user can add the specific name of the individuals filling those roles. The tool provides a pre-populated definition of the key roles and allows the user to further define additional roles as they see fit. Chief roles include:
   1. Crisis Team Leader
   2. EPM Coordinator
   3. Communications
   4. Operations
d) Rally Points—Lets the user identify specific rally points and optionally add photographs.
e) Response Protocols—Lets the user specify response protocols and assigned colors. This feeds into the “Quick Action Guide.”

### Network

Still referring to FIG. 1, one embodiment of the present invention is shown in a block diagram. FIG. 1 shows several advantageous features of the present invention, but, as will be described below, the invention can be provided in several shapes, sizes, combinations of features and components, and varying numbers and functions of the components. The first example of a network 100 of data processing systems in which the present invention may be implemented, as shown in FIG. 1, includes connections 102a-n, which are the medium used to provide communications links between various devices and computers connected together within the network 100. The connections 102a-n may be wired or wireless connections. A few exemplary wired connections are cable, phone line, and fiber optic. Exemplary wireless connections include radio frequency (RF) and infrared radiation (IR) transmission. Many other wired and wireless connections are known in the art and can be used with the present invention.

In the depicted example, the network 100 includes an electronic device 104 and a server system 106. As used herein, the electronic device 104 also represents the user that operates or communicates through the electronic device 104. Therefore, throughout the remainder of the specification, where the term “user” is used, it can be implied that the user may refer to the electronic device 104 operated by or utilized by the user to communicate with the server system 106.

In the depicted example, the network 100 can include the Internet 108, which represents a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, the network 100 also may be implemented as a number of different types of networks, such as for example, an Intranet, a local area network (LAN), or a wide area network (WAN). FIG. 1 is intended as an example, and not as an architectural limitation for the present invention.

In one embodiment, the server system 106 may be implemented on a single server computer. In another embodiment, the server system 106 may include more than one server computer, as may be the case where the server system 106 is implemented in the cloud. In one embodiment, the server system 106 can be seen as a software application or computer program and/or hardware that is responsible for accepting inputs from the user, or client, and serving the user/client with responses. In an embodiment, where the Dashboard is implemented as a web-based tool, the server system 106 can be seen as hardware and/or a computer program responsible for accepting HTTP requests from the electronic device 104 and serving the electronic device 104 with HTTP responses along with optional data contents, which are usually web pages such as HTML documents and linked objects (images, etc.).

The server system 106 may also store user-inputted data on a database associated with the server system 106. In some embodiments, the server system 106 may be seen as the data processing system used to implement one or more of the process steps described herein. The server system 106 may also receive, through the Dashboard or other user application interface, payment details associated with a subscription, user-inputted answers to emergency/crisis-related questions, user-inputted information related to response protocols, etc. In addition, the server system 106 may receive user input, process and/or analyze said user input, store the results of the processed user input (e.g., a threat ranking, assessment matrix, response protocols, quick action guide, gauge levels, etc.), and/or send the results and other associated information to the electronic device 104.

In one embodiment, the server system 106 may store an electronic copy of a quick action guide 110, which is discussed herein in more detail below. Accordingly, the electronic device 104 may, when the user is logged-in to the user's account, retrieve the electronic copy of the quick action guide 110 stored on the server system 106 and print a physical copy of the quick action guide 110 on a local printer communicatively coupled to the electronic device 104, or otherwise produce a physical quick action guide 110. The quick action guide 110 may depict (pictorial and/or written) the one or more response protocols for use later by the user, as described herein.

The network 100 may include additional servers and other devices and entities not shown. In the depicted example, the electronic device 104, which is represented as a mobile computing device, communicates with the server system 106. The device 104 is said to be “computing” as it is operable to accept and serve HTTP requests from the EPM server 106 and serve the electronic device 104 Communication between the devices coupled to each other on the network 100 may occur through the Internet 108, or another wireless or wired data exchange method, e.g., Bluetooth, radio frequency identification (RFID), or near field communications (NFC). Moreover, any of the depicted network entities, in addition to communicating with each other over the network 100, are, in some embodiments, also able to communicate in a peer-to-peer relationship using wired or wireless links. In embodiments of the present invention, various computing entities located on the network 100 may perform all, or some, of the above-described steps of the present invention represented in FIG. 1 or otherwise disclosed herein.

### Server/Electronic Device

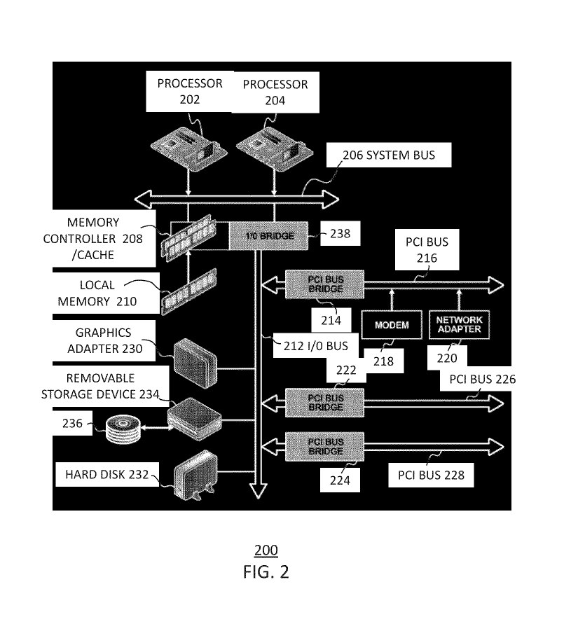

Referring to FIG. 2, a block diagram of a data processing system 200 that may be implemented as a server, such as a server of the server system 106, or implemented as a personal computer or electronic device associated with such servers, as shown in FIG. 1, in accordance with one embodiment of the present invention. The data processing system 200 may be a symmetric multiprocessor (SMP) system including a plurality of processors 202 and 204 connected to system bus 206. Alternatively, a single processor system may be employed. Also, connected to the system bus 206 is a memory controller/cache 208, which provides an interface to local memory 210. An I/O bus bridge 238 is connected to a system bus 206 and provides an interface to an I/O bus 212. The memory controller/cache 208 and the I/O bus bridge 238 may be integrated as depicted. The processor 202 or 204 in conjunction with the memory controller 208 controls what data is stored in memory 210. The processor 202 and/or 204 and the memory controller 208 can serve as a data counter for counting the rate of data flow to the memory 210 or from the memory 210 and can also count the total volume of data accessed to or from the memory 210. The processor 202 or 204 can also work in conjunction with any other memory device or storage location.

A peripheral component interconnect (PCI) bus bridge 214 connected to an I/O bus 212 provides an interface to a PCI local bus 216. A number of modems 218, or wireless cards, may be connected to the PCI bus 216. Typical PCI bus implementations will support four PCI expansion slots or add-in connectors. PCI includes, but is not necessarily limited to, PCI-X and PCI Express components. Communications links to the network of computers in FIG. 1 may be provided through the modem 218 and a network adapter 220 connected to the PCI local bus 216 through add-in boards.

Additional PCI bus bridges 222 and 224 provide interfaces for additional PCI buses 226 and 228, from which additional modems or network adapters may be supported. In this manner, the data processing system 200 allows connections to a multiple network of computers. A graphics adapter 230 and a hard disk 232 may also be connected to the I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The Dashboard is explained in detail below and can be embodied in a computer program. Computer programs (also called computer control logic) are stored in memory such as main memory 210, a removable storage drive 234, removable media 236, a hard disk 232, and signals. Such computer programs, when executed, enable the computer system to perform the features of the present invention as discussed herein. In particular, the computer programs, when executed, enable the processor 202 and/or 204 to perform the features of the Dashboard or other user application interface, or the server system 106.

In this document, the terms “computer program medium,” “computer usable medium,” and “computer readable medium” are used to generally refer to media such as main memory 210, removable storage drive 234, removable media 236, hard disk 232, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired or wireless network, which allows a computer to read such computer readable information.

The electronic device 104 also includes a computing means, e.g., a processor, and a storing means, e.g., a memory. The processor is operable to run one or more programs/applications and interfaces associated with the electronic device 104 or stored on the memory in order to effectuate the data transfer and communications required by the present invention. The electronic device 104 may also have other components or features that include an accelerometer, a gyroscope, a GPS system, a proximity meter used to detect the proximity of the user to the electronic device 104, an image capturing element configured to capture images and/or videos, an ambient light sensor configured to capture and ascertain lighting conditions, a microphone, or any additional element typically associated with the electronic device 104 such as a phone.

The above-described hardware is useful for implementing the present invention, which facilitates communication between the electronic device 104 associated with the user and the server system 106 in order to provide an emergency and crisis plan that effectively utilizes weighted user-inputted data to generate protocols tailored for each individual user for use by the user after an emergency situation arises.

### Exemplary Method

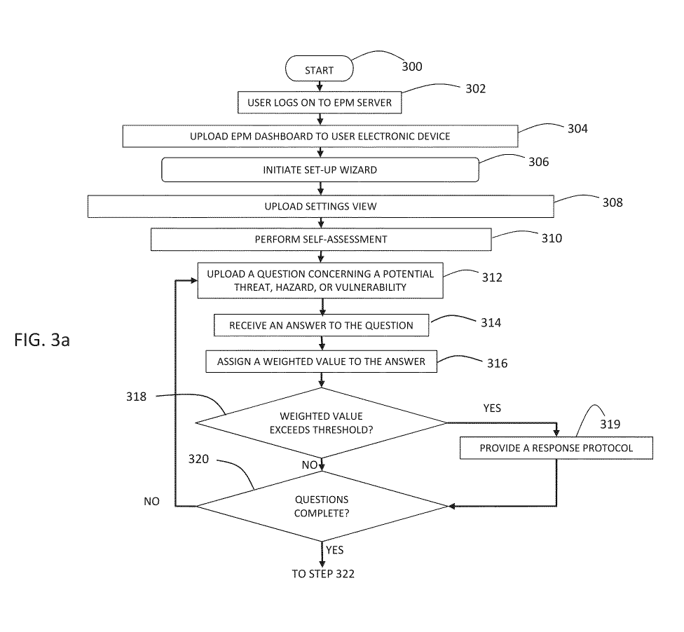

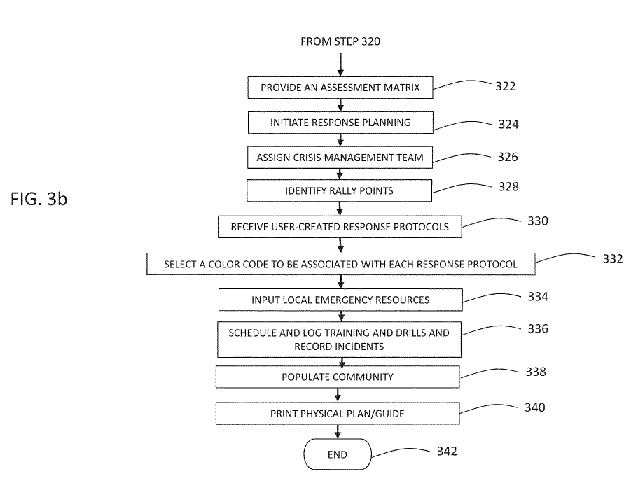

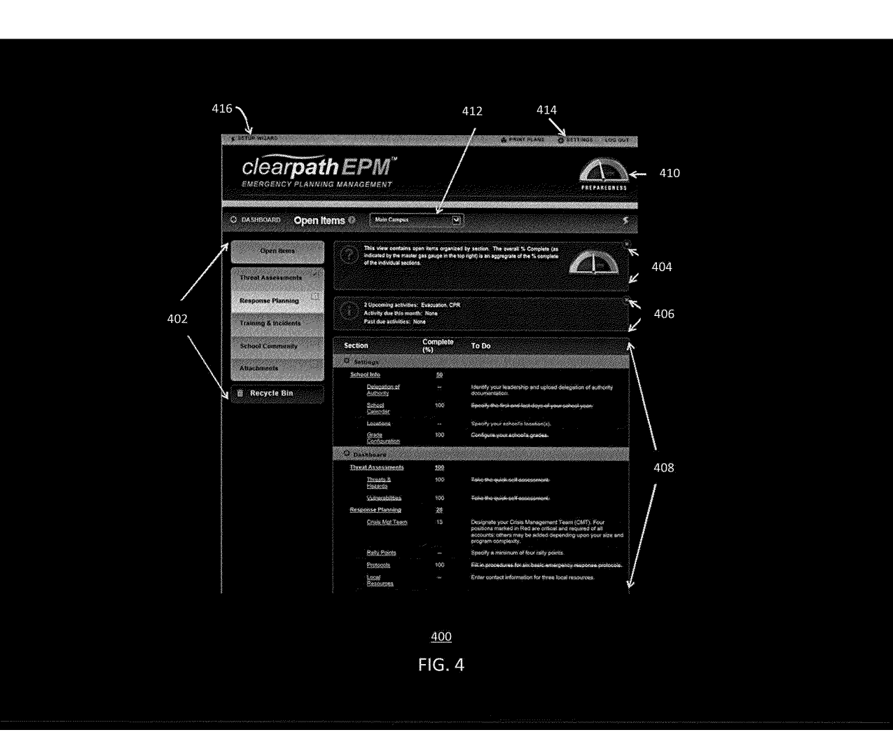

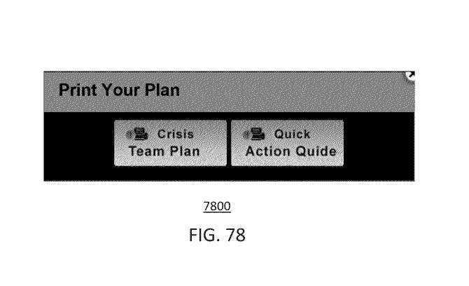

FIGS. 3a and 3b illustrate a single process flow of one embodiment of the present invention. The process flow provides exemplary steps for carrying out an exemplary embodiment of the present invention. The invention, however, is not limited to the number or order of steps shown in FIGS. 3a and 3b. Also, two or more steps shown in succession may be executed concurrently or with partial concurrence in some embodiments. Certain steps may also be omitted in FIGS. 3a and 3b for the sake of brevity. The process of FIGS. 3a and 3b will be described with reference to the network diagram of FIG. 1 and the screenshots depicted in FIGS. 4 through 78.

The flow starts at step 300 and moves directly to step 302 where a user logs in to the server system 106 over a network through, for example, the Internet 108. Web pages are well known in the art and are a resource of information that is suitable for access over the Internet 108 and can be accessed through a web browser running on a computing system, such the user's computer. Logging-in may also be accomplished through the user's electronic device 104. Web pages may consist of files of static text stored within the server system's 106 file system (static web pages), or a web server may construct the (X)HTML for each web page when it is requested by a browser (dynamic web pages). Client-side scripting can make web pages more responsive to user input once in the client browser. Web pages are requested and served from web servers using Hypertext Transfer Protocol (HTTP). This information is usually in HTML or XHTML format, and may provide navigation to other web pages via hypertext links within the page. The web pages may also be used in combination with any kind of extensible markup language (XML) document, including plain XML, scalable vector graphics (SVG), and XML user interface language (XUL).

In one embodiment, the user installs and launches a software application on the electronic device 104 that facilitates the log-in with the server system 106. The user then uses the electronic device 104 to upload a user-identifier with the server system 106. This user-identifier may include a unique log-in user name or password. This may also include user-identifying information such the user's address, phone number, a photo of the user, biometric data, e.g., retinal/facial scan and fingerprints, and other user-identifying information. This user-identifying information may also be received and associated with any authorized persons desired by the user, e.g., a child/parent of the user. When the user uploads at least one piece of user-identifying information, a “user account” is created that resides on, or is otherwise accessible to, the server system 106 for future reference. This user-identifying information may be stored on a database that is communicatively coupled to the server system 106. In other embodiments, financial information of the user, e.g., credit/debit card information, may also be received by the server system 106 and stored on the database. This financial information may be associated with a subscription model that allows the user to remotely access and update their emergency plan and associated information stored on the server system 106.

This transfer of information may occur through the Dashboard, which permits the user to provide and/or upload user-inputted answers to emergency plan-related questions such as, for example, financial information, user-identifying information, maps associated with rally points, emergency contacts, blue prints, videos, documents, and the like. The information may be encrypted prior to storing or to transmitting across the network 100. The information may be encrypted prior to storage on the server system 106. Moreover, user-identifying information relating to multiple users associated with the user account may also be stored on the server system 106.

After the user successfully logs in to the server system 106, the server system 106 may upload the EPM Dashboard to the user's electronic device 104, in step 304, where the user can upload or access information stored on the server system 106, and input information that allows the server system 106 to generate a user-tailored emergency and crisis management plan.

With reference now to FIG. 4, there is depicted an exemplary screenshot 400 representing the EPM Dashboard after the log-in step 302. The EPM Dashboard provided to the electronic device 104 of the user is associated with the user-identified account, providing information unique to the user's account. The EPM Dashboard may be formed as a computer-displayable user interface operable to accept user input from a user input interface (e.g., keyboard, mouse, touchscreen, etc.) communicatively coupled to the electronic device 104 of the user. The EPM Dashboard may also send the user input to a remote database associated with server system 106 and present information in real-time on the electronic device 104 of the user based on the user input. Because the user input is stored on the server system 106, the information is accessible by the user via one or more electronic devices of the user as a result of the user logging-in to the user-identified account. Accordingly, multiple users with different electronic devices may be able to access the information. Also, the user may be able to access the information via any electronic device communicatively coupled to a network, such as the Internet 108.

The screenshot 400 depicts an exemplary web page structure and web elements. In one embodiment, the Dashboard includes a main navigation area 402, a section help area 404, an open activities area 406, a main section 408, a gauge element 410, a location toggle bar 412, a settings view link 414, and a set-up wizard link 416. In one embodiment, the main navigation area 402 includes a menu with a plurality of links associated with different categories of emergency/crisis planning information. Each link may include a drop-down menu further segmenting the main categories into child sub-categories associated with the main categories. By clicking on the link, the user can populate the main section 408 with information associated with the selected category or sub-category in order to interact with the server system 106, inputting and uploading information and receiving responses from the server system 106. In one embodiment, the plurality of links in the main navigation area 402 can include a link for open items, threat assessments, response planning, training & incidents, school community, attachments, and a recycle bin. In another embodiment, a set-up wizard follows the top-down workflow of categories/links in the main navigation area 402, such that, for example, the user may begin with threat assessments, and then continue populating the account by working down the list of categories via a logical top-down workflow, until the user reaches the last category, e.g., the attachments category, where the user can upload maps, blue prints, video, documents, and the like to the server system 106 for later retrieval after an emergency arises, or during a training session. Although the exemplary embodiment of the Dashboard is shown supporting a school system in developing emergency/crisis management planning, it is understood that the present invention is not limited to only schools and may be used by other users or entities for emergency/crisis management planning.

In one embodiment, the section help area 404 automatically opens on each page and generally describes to the user the content and/or purpose of the corresponding page element displayed in the main section 408. In another embodiment, the open activities area 406 is only displayed as a result of the user clicking on the “open items” link in the main navigation area 402. The open activities area 406 may describe upcoming activities within the user's emergency management plan, activities within said plan that are due to be performed in the current month, activities that have passed a scheduled deadline, and the like. This allows the user to keep track of upcoming and overdue activities and deadlines associated with the emergency management plan.

In one embodiment, the main section 408 can be considered a primary focal area for each category and associated page. The main section 408 displays information associated with the currently selected category from the main navigation area 402 and allows the user to input related information to the server system 106.

In one embodiment, the gauge element 410 may represent overall preparedness of the user to respond to an emergency or crisis. In another embodiment, the gauge element 410 may represent the user's completion of each category or sub-category of the top-down workflow process for setting-up the user-tailored emergency/crisis management plan. For example, there may be a gauge element 410 that represent a level/amount of completion for each category and/or sub-category listed in the main navigation area 402. The gauge element 410 may be presented to the user on at least a portion of the EPM Dashboard. The gauge element 410, as illustrated in FIG. 5, may define a graphical, computer-displayable visual depiction of the user's emergency planning management preparedness level. In one embodiment, this emergency planning management preparedness level indicated by the gauge element 410 may be based on the user's input to the server system 106. The user's input may be, for example, answering questions concerning a potential threat, a potential hazard, and/or a potential vulnerability associated with the user; inputting grades, rally points, requested dates, scheduled trainings, user contact information, and the like. For example, as a result of the user inputting particular information and completing portions of a set-up wizard, the gauge element 410 may increase the preparedness level of the user associated said portions and information, as will be explained in more detail below.

In one embodiment, the location toggle bar 412 may allow a user associated with multiple locations (e.g., a school with more than one campus location) to toggle between emergency planning management information associated with each location.

### Settings View

In one embodiment, the settings view link 414 provides a link for the user to transition to the settings view of the EPM Dashboard. The settings view may present a portion of the user's account used for administrative activities, as opposed to, for example, workflow activities. The settings view may allow the user to add, edit, and delete, for example, users, schools, locations, etc. The settings view may allow the user to update billing and financial information and attend to other administrative activities associated with the user's account. In another embodiment, the settings view may allow the user to review system activity, such as, for example, date and user-specific content information, which may also indicate what information was added, edited, or deleted and at what time and performed by which user associated with the account. The settings view may be considered an administrative portion of the EPM Dashboard. In yet another embodiment, the settings view may also contain location and account specific information, such as, an identification of an individual that has the ultimate responsibility for the user's account.

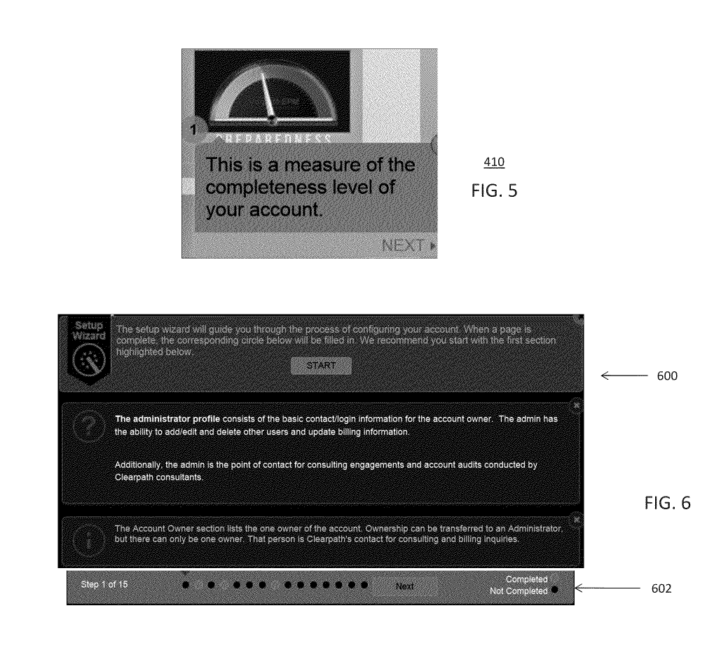

In one embodiment, the set-up wizard link 416 may provide the user with a link to a set-up wizard 600 (see FIG. 6) that guides a new user through a plurality of key elements or categories of the overall EPM Dashboard. In another embodiment, the set-up wizard 600 allows the user to view a visual indication 602 of which of the plurality of key elements have been completed by the user and which of the key elements have not been completed by the user yet (see FIG. 6).

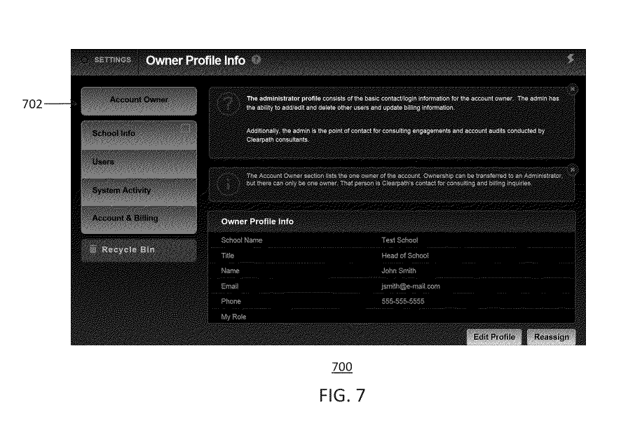

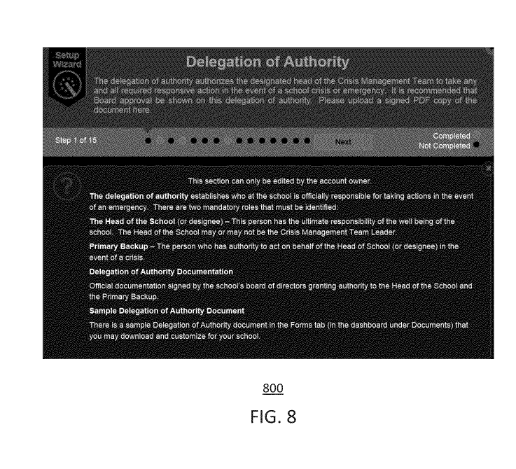

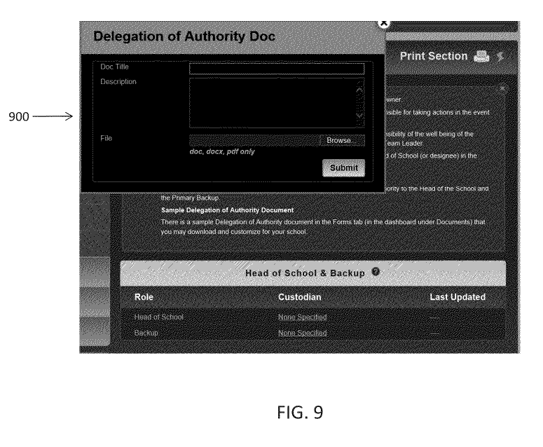

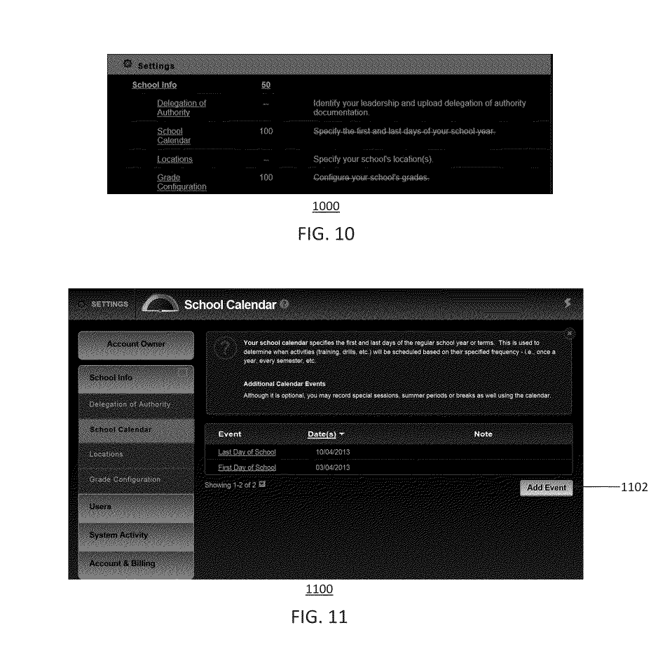

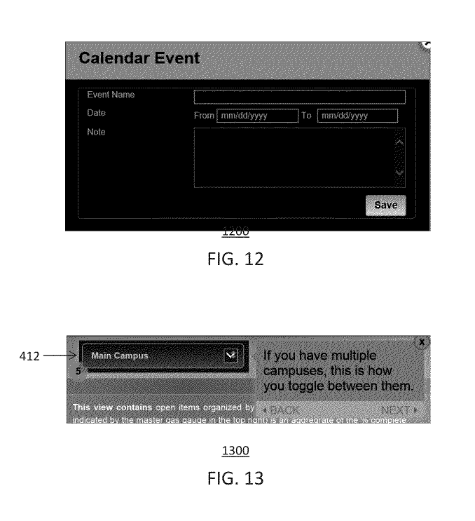

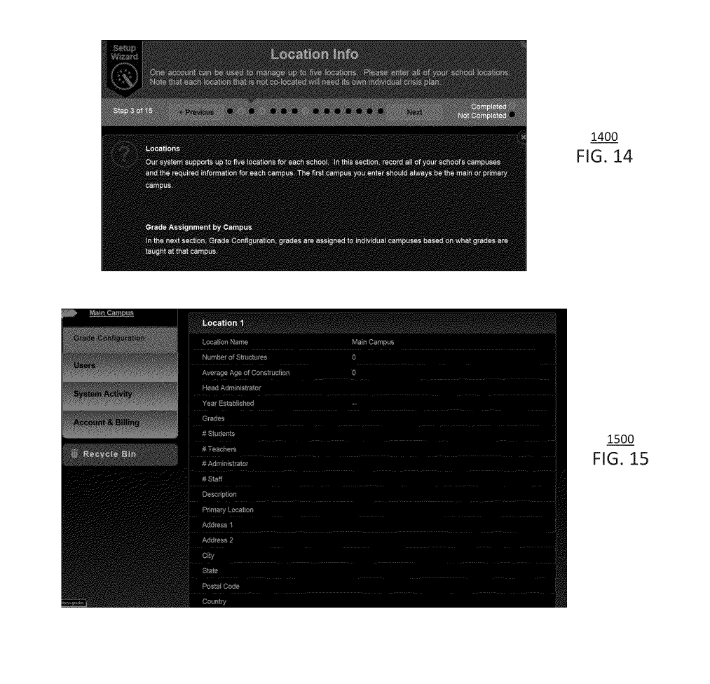

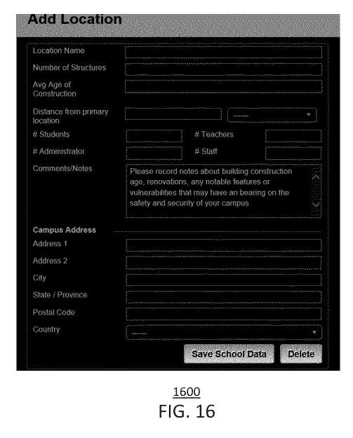

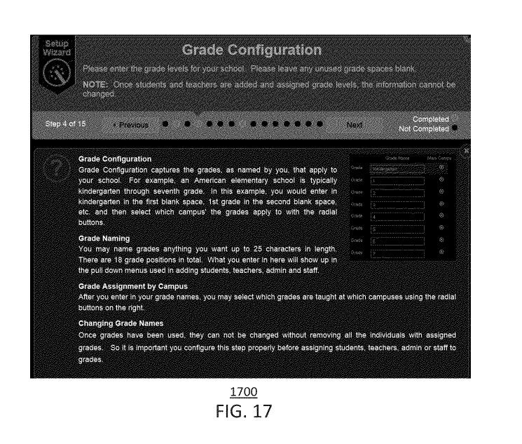

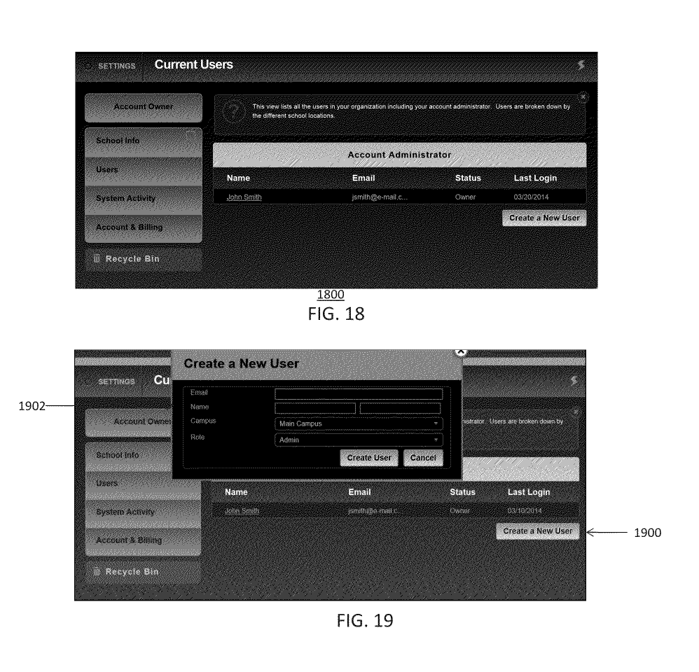

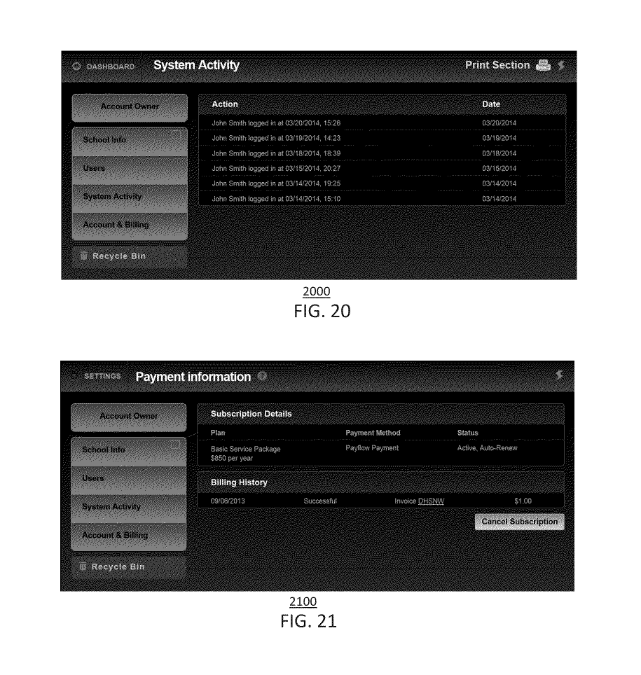

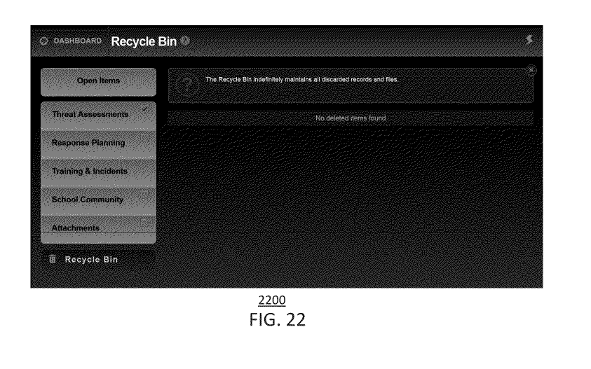

Referring now again to FIG. 3a with reference to FIG. 1 and FIGS. 6-22, the user clicks on the set-up wizard link 416 (FIG. 4) to initiate the set-up wizard 600, in step 306. In step 308, the server system 106 uploads the settings view, which may include one or more web pages associated with administrative set-up activities. In one embodiment, the set-up wizard 600 guides the user to inputting information associated with an owner profile 700. The owner profile 700 may be a user profile associated with an individual who initially registered for the service provided by the EPM Dashboard and the server system 106. In another embodiment, ownership can be re-assigned to another administrative user by, for example, creating a new administrative user and then re-assigning ownership in an account owner web page associated with an account owner link 702. In yet another embodiment, within the settings view, the user may be prompted to complete a delegation of authority 800, which may indicate a primary and/or back-up school custodian (or other responsible individual) that is primarily responsible for the emergency/crisis management planning of the school/user. As illustrated in FIG. 9, the user may be prompted to upload a “Delegation of Authority” document 900, which may be an official document signed by, for example, the school's board of directors. As used herein, the term “user” may refer to the overall user of the EPM Dashboard, such as a school, or one of a multitude of individuals associated with the school that has access to the server system 106 and may be associated with a user-profile unique to the individual, such as the owner profile 700. In one embodiment, uploading the Delegation of Authority document 900 may be an item that transitions the associated gauge element from indicating a low level of preparedness (e.g., a red section of the gauge element) to a high level of preparedness (e.g., a green section of the gauge element). In another embodiment, completion of the settings category may include completion of a plurality of sub-categories 1000 associated with the settings category, such as, for example, the delegation of authority action items discussed above, school calendar action items, location-related action items, and a grade configuration. In yet another embodiment, the plurality of sub-categories 1000 may be tailored to the type of institution, entity, or individual represented by the user. Completion of such sub-categories may determine the level/amount of preparedness indicated by a settings category gauge element.

In one embodiment, the user may be prompted to complete a school calendar section 1100 that may be used to schedule emergency planning management training sessions throughout the school year. There may be an event button 1102 that allows the user to enter calendar events for the school calendar in a calendar event pop-up interface 1200. For an EPM Dashboard associated with a multi-location user, such as a school, the user may be presented with a prompt 1300 explaining the location toggle bar 412 (see FIG. 4). In addition, the user may be requested to complete a school location section 1400, where the user may enter information specific to each unique school location or campus. The server system 106 may then allow the user to toggle between each location and present information, via the EPM Dashboard, specific to said toggled-to location. In one embodiment, completion of the school location section 1400 may be a gauge item. Accordingly, the user may be required to complete the school location section 1400 in order to transition the associated gauge element from indicating a low level of preparedness (e.g., a red section of the gauge element) to a high level of preparedness (e.g., a green section of the gauge element). In another embodiment, the user may be required to input school location information 1500 in the school location section 1400 for all campus locations associated with the school's account. This may be performed through an add location dialogue box 1600 presented to the user via the EPM Dashboard.

Another section that may be considered a gauge item for a school EPM Dashboard is a grade configuration section 1700, where the user may enter information indicating grade levels associated with the school. Preferably, the settings sections may be tailored to the type of institution, entity, or individual associated with the user.

In one embodiment, each user account has a predetermined number of allowable users. This predetermined number may be based on the user account's purchased plan. The settings view may also allow the account administrator to identify each user associated with the account. In a further embodiment, users may be associated with a particular school location. In one embodiment, the settings view may allow an administrator to view a list of account users 1800. The EPM Dashboard may include a “create a new user” button 1900 that generates a “create a new user” prompt or dialogue box 1902 in which new user information can be entered. The server system 106 may also be configured to record and store all user actions (e.g., create, edit, delete, etc.) including a time and date associated with each user action. The EPM Dashboard may present a system activity section 2000 that presents to, for example, an administrator, all user actions including a time and date associated with each user action.

In one embodiment, the EPM platform may be integrated with a payment processing service, such as PayPal, a member and subscription management software for subscription management. The EPM Dashboard may include a payment information page 2100 within the settings view that displays, for example, the user's plan package and status and billing history. In one embodiment, the EPM Dashboard may include a recycle bin 2200 that maintains all discarded records and files.

### Dashboard View

In one embodiment, separate from the settings view, the EPM Dashboard may provide a dashboard view that is considered the working portion of the EPM Dashboard, whereas the settings view may be considered the administrative portion of the EPM Dashboard for administrative, billing, and basic account configuration information.

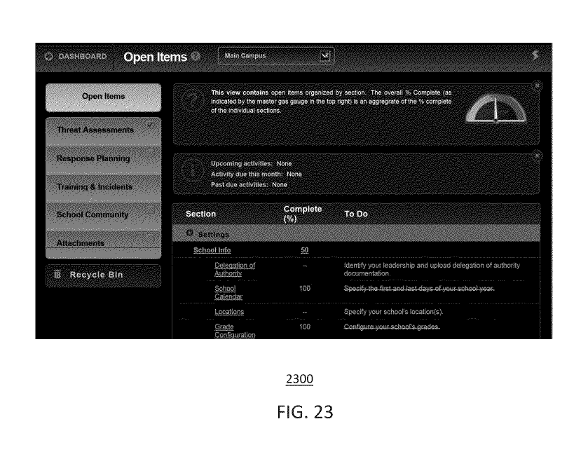

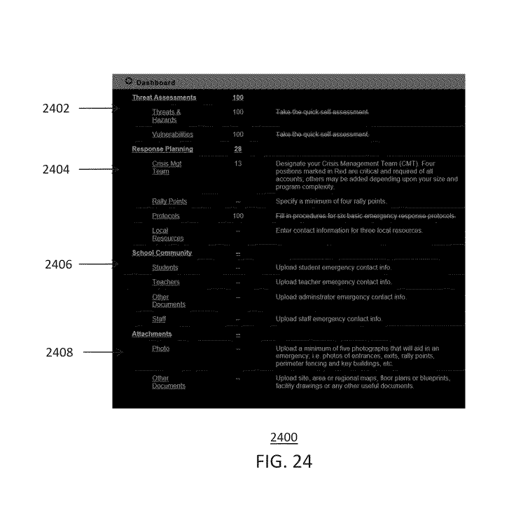

In one embodiment, the EPM Dashboard provides an open items view that may summarize all the individual sub-sections (small gas gauge elements) that provides input fields whose input drives the overall preparedness level (large gas gauge element) of the account. The open items view may be the default view of the EPM Dashboard. FIG. 23 presents an embodiment of the open items view portion 2300 associated with the settings and FIG. 24 presents an embodiment of the open items view portion 2400 associated with the main dashboard. The dashboard open items view 2400 is shown segmented into four sections: a threat assessment section 2402, a response planning section 2404, a school community section 2406, and an attachments section 2408. The set-up wizard 600 (not shown) may guide the user through each of the four dashboard sections in a top-down workflow.

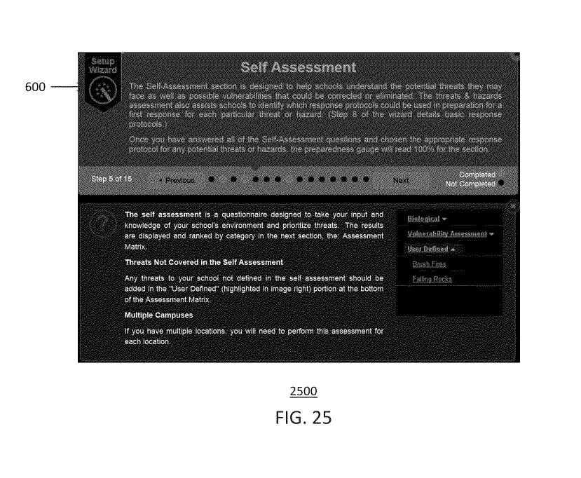

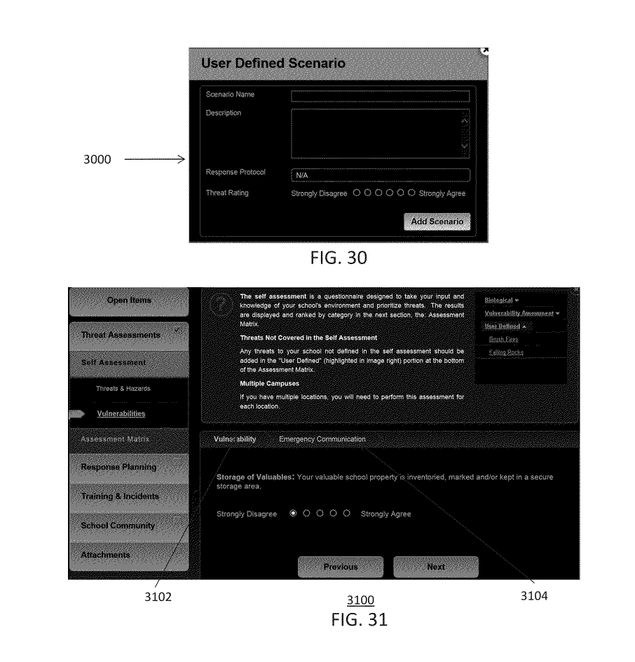

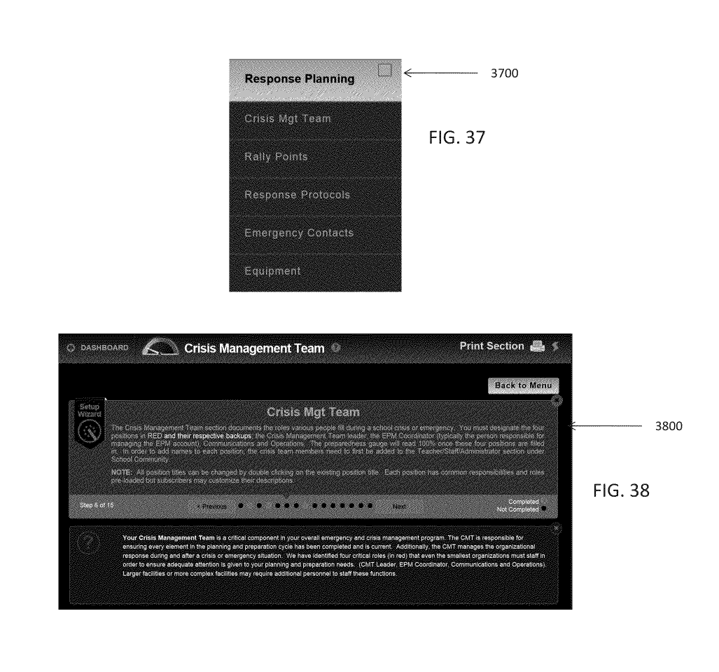

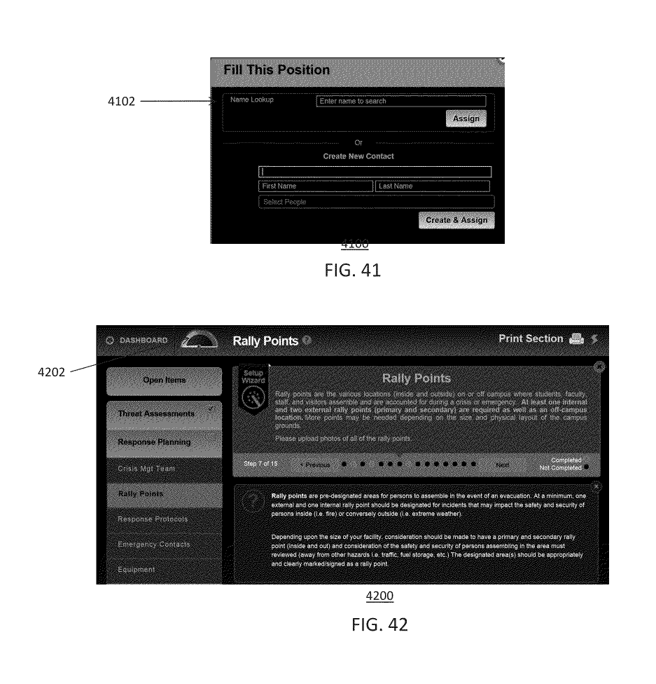

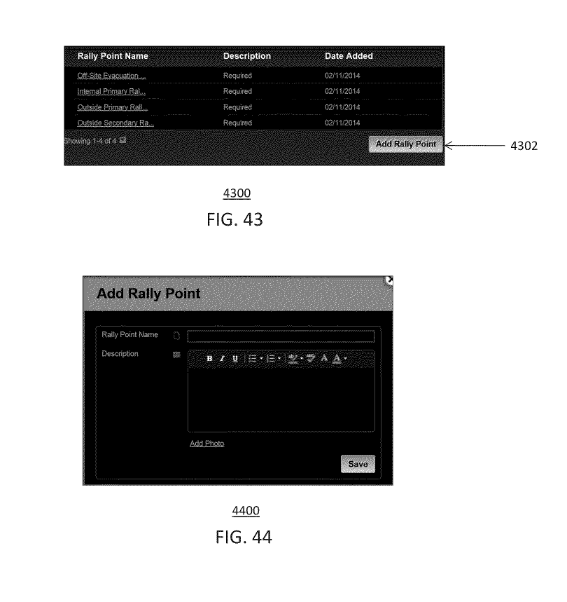

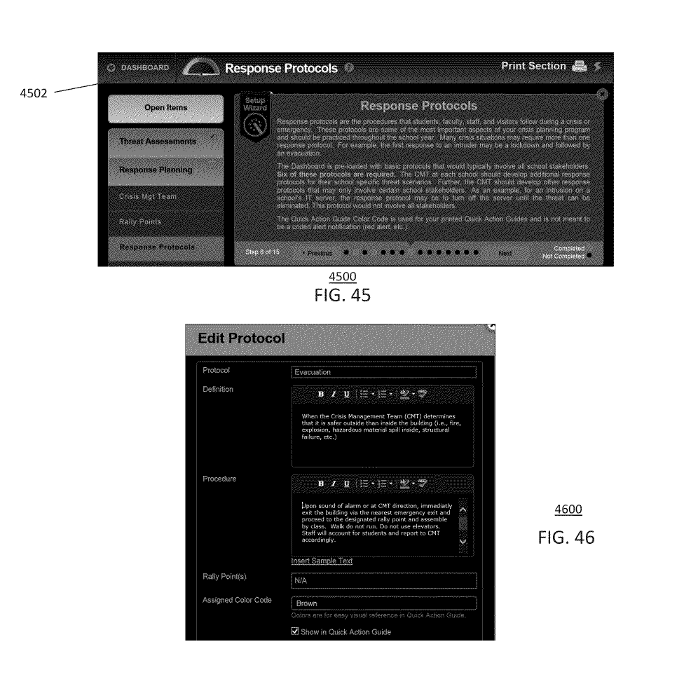

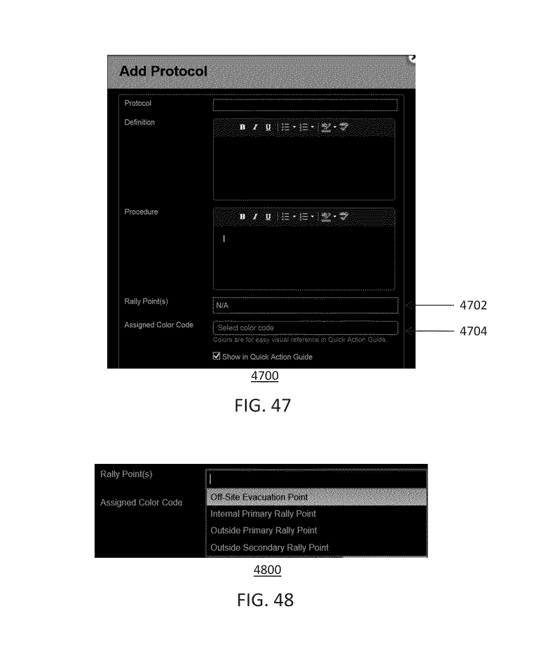

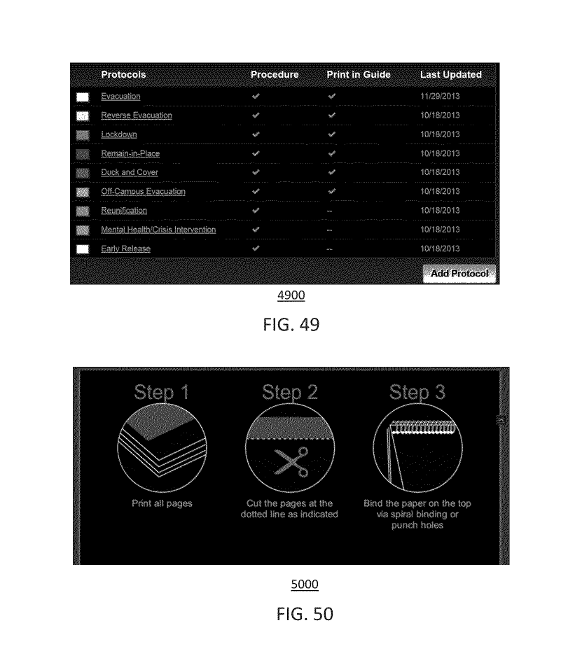

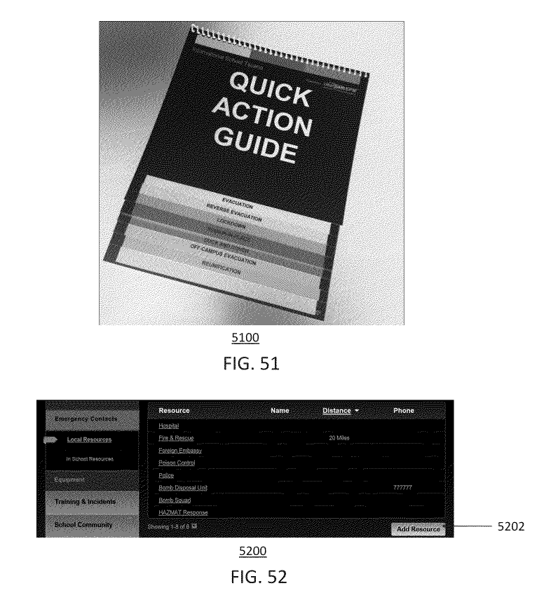

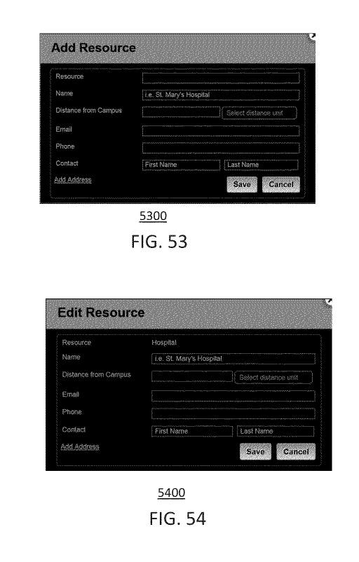

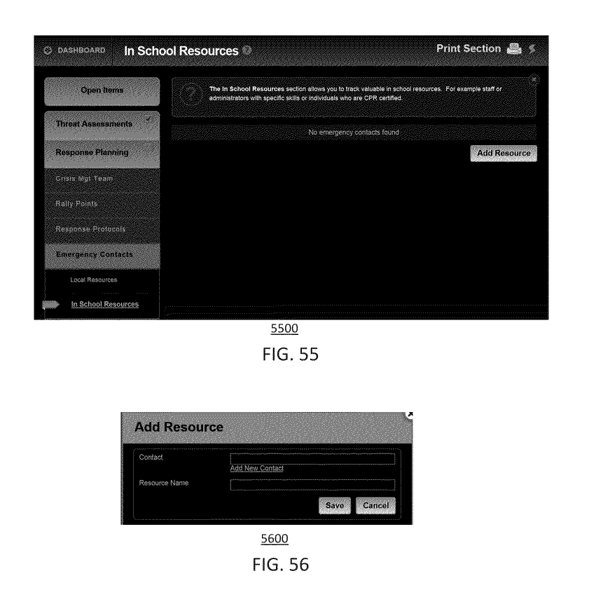

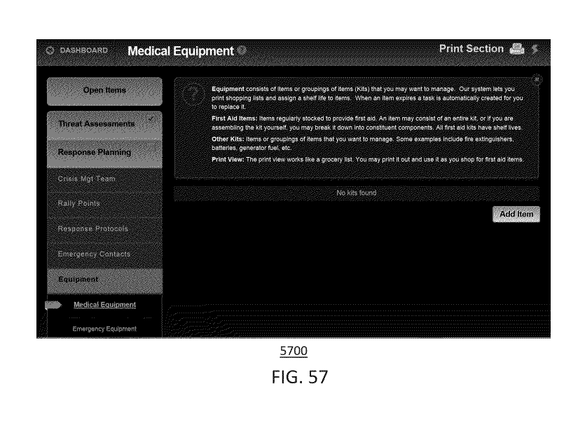

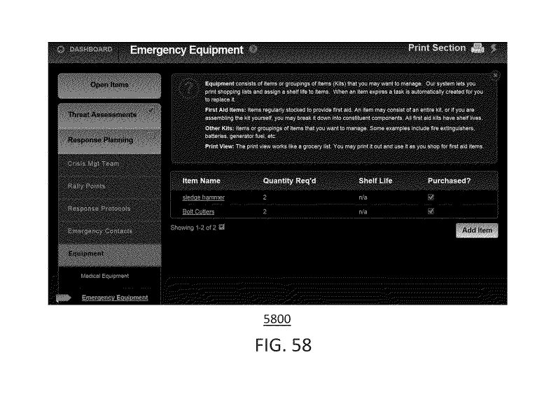

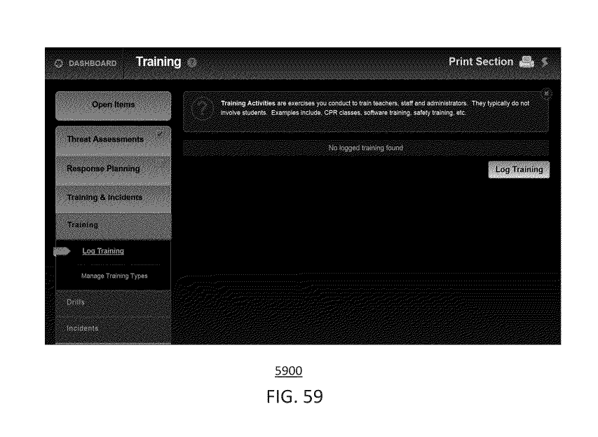

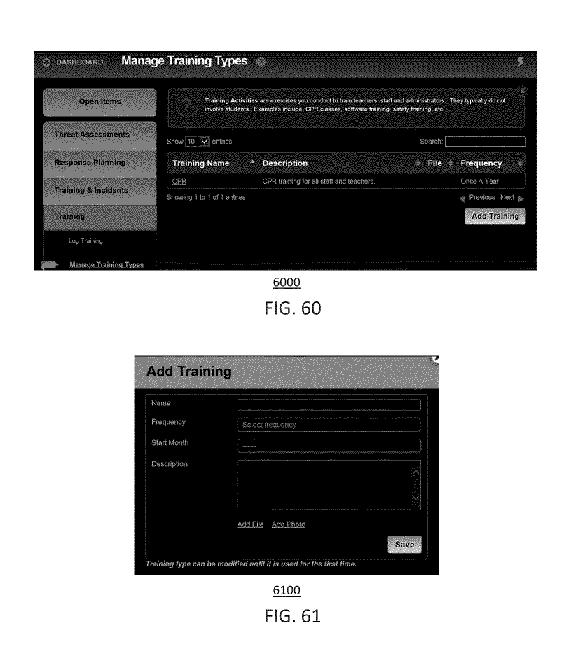

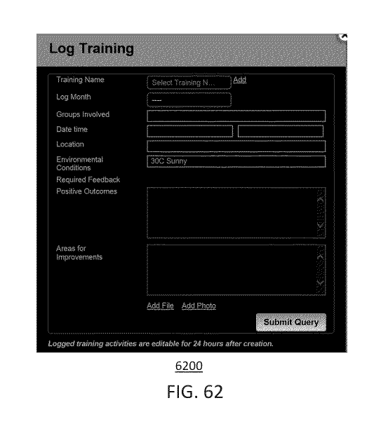

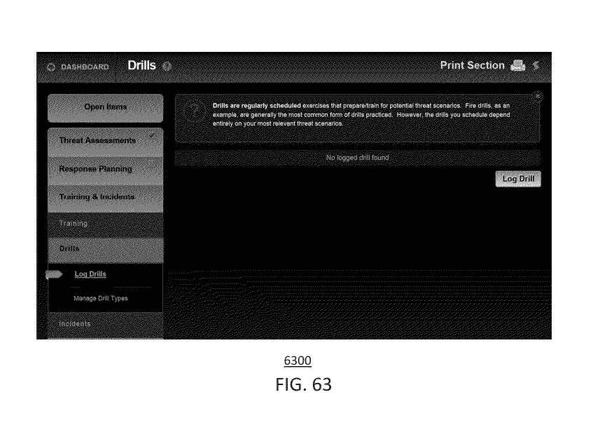

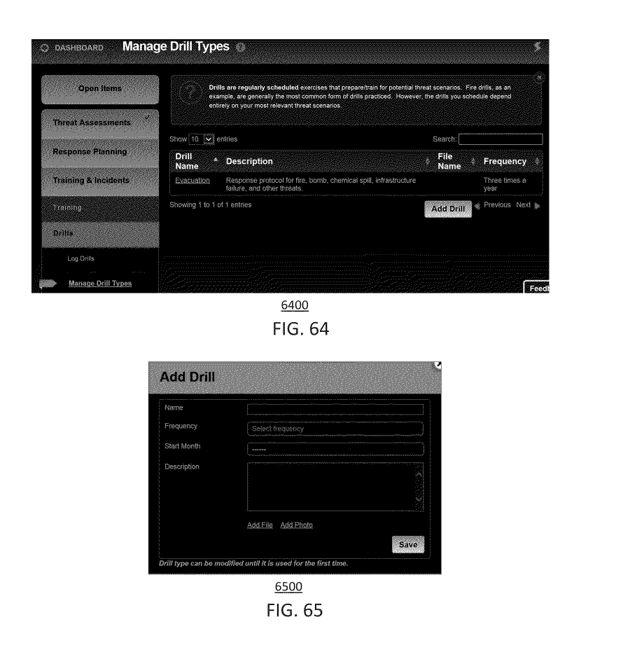

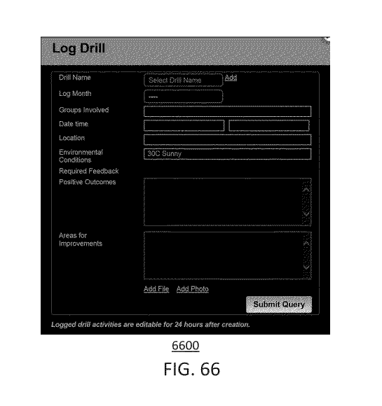

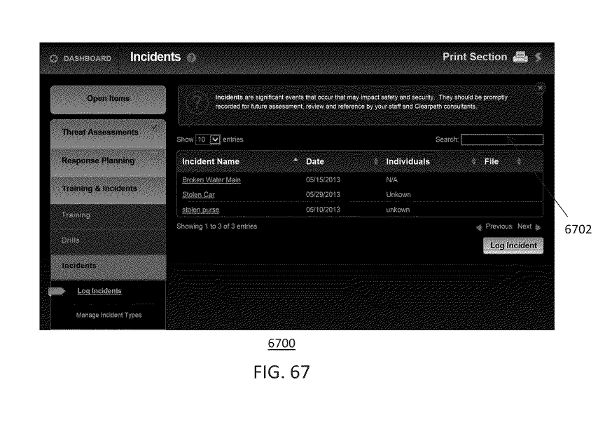

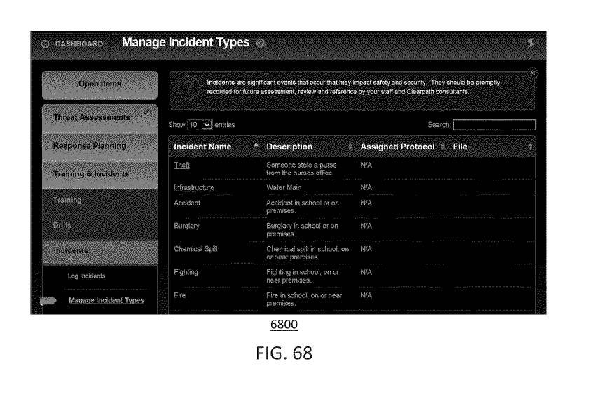

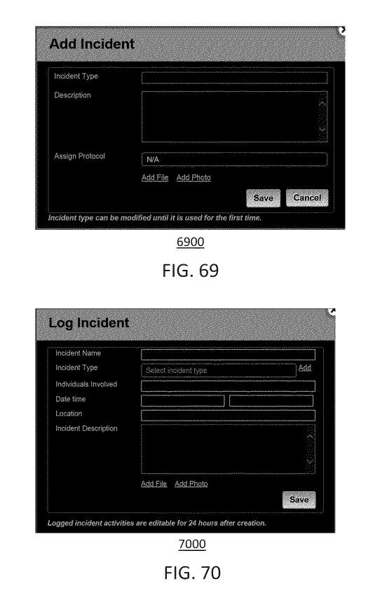

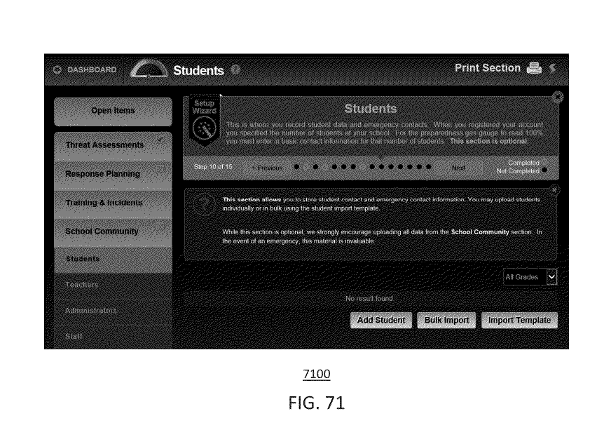

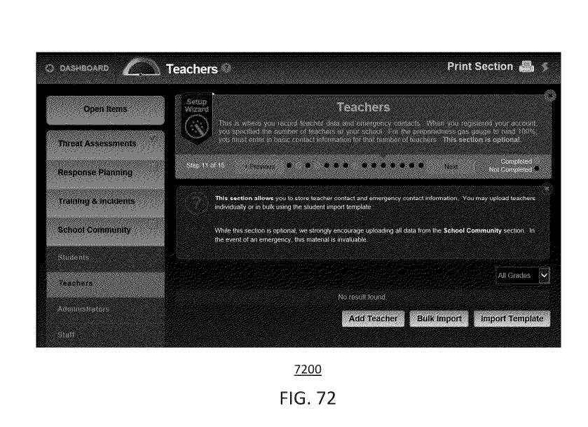

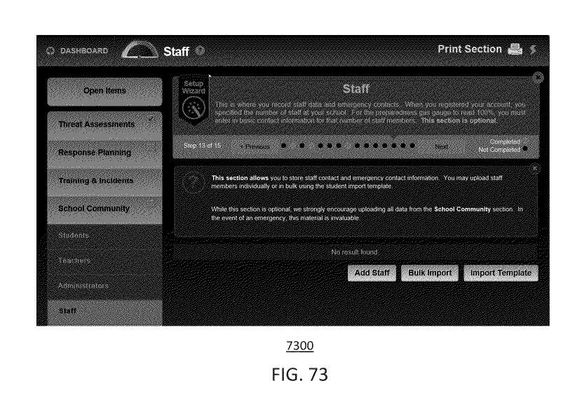

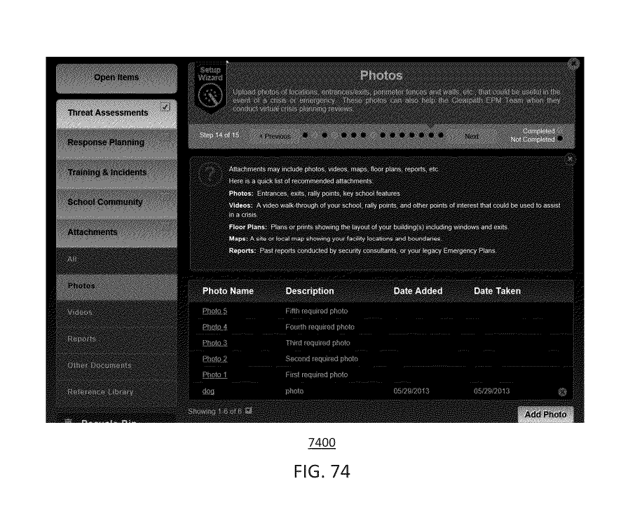

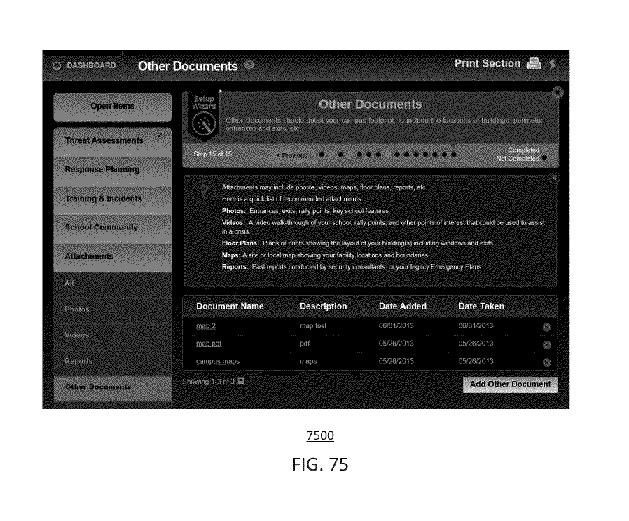

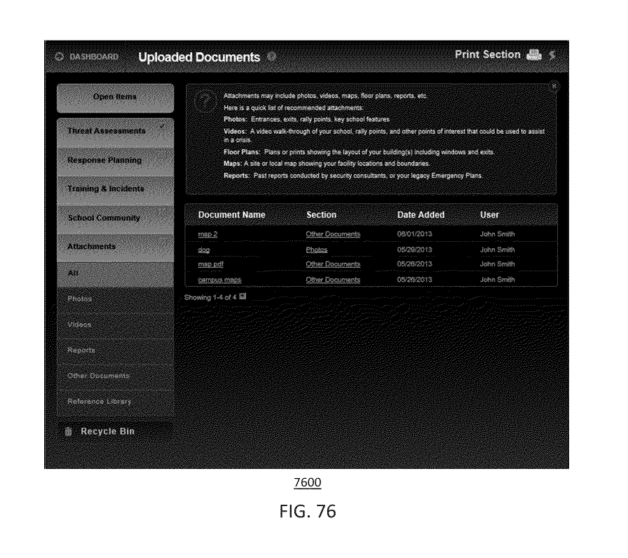

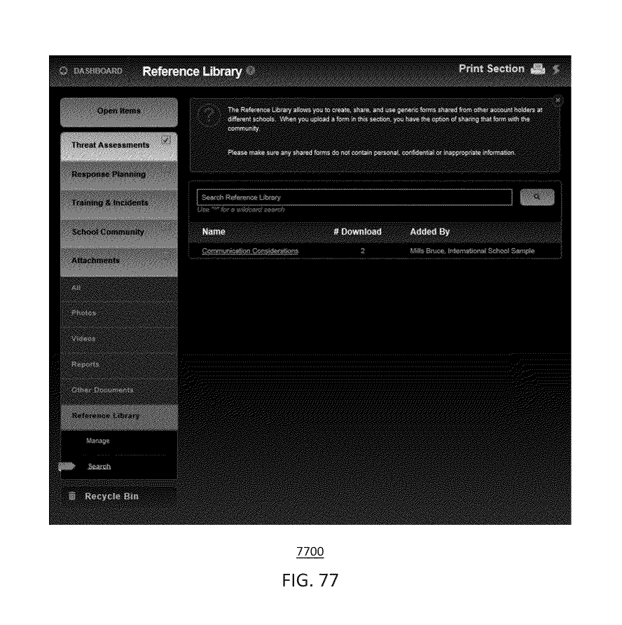

Referring to FIGS. 3a-3b with reference to FIG. 1 and FIGS. 24-78, the remaining steps of the exemplary process are described. In step 310, the user performs a self-assessment. The self-assessment assists the user with understanding and identifying potential threats and potential vulnerabilities. The set-up wizard 600 may provide a self-assessment section 2500 that explains the self-assessment and guides the user through the self-assessment steps. In one embodiment, the self-assessment includes a threat assessment 2600 that can be segmented into a threats and hazards section 2602 that ties into an assessment matrix section 2604. The self-assessment can be considered a questionnaire designed to take in the user's input and knowledge of the school's environment and output a plan that prioritizes threats, which may be displayed and ranked by category in the assessment matrix section 2604. In one embodiment, the threats and hazards section 2602 includes five threat categories, with each category having its own set of questions. In one embodiment, the five threat categories may include natural threats 2606, human threats 2608, technological threats 2610, infrastructural threats 2612, and biological hazards 2614. In another embodiment, there may be more than five threat and hazard categories or less than five threat and hazard categories.

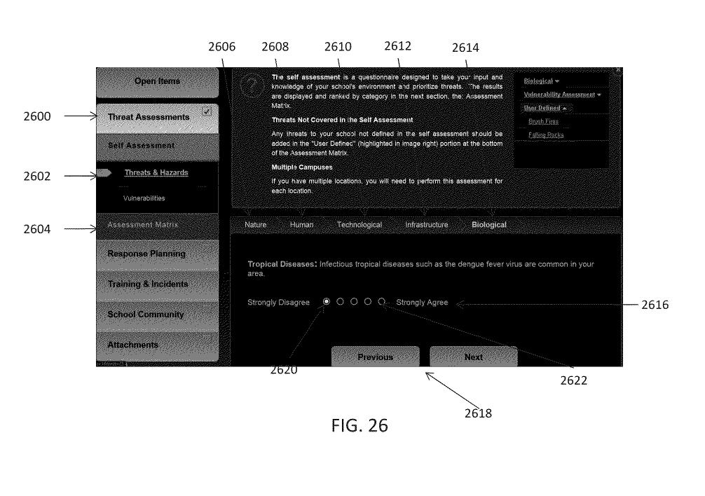

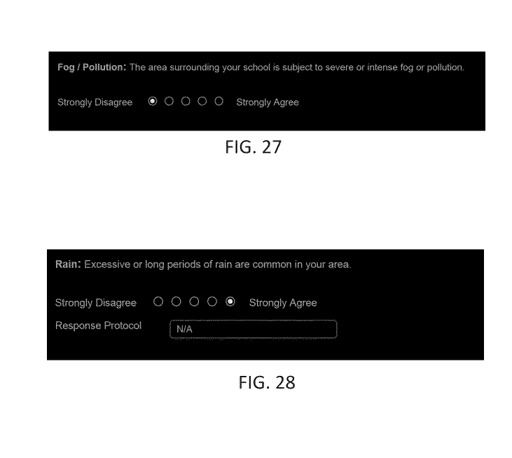

In step 312, the server system 106 may upload one or more questions concerning a potential threat, hazard, or vulnerability, as part of the self-assessment. The question may be displayed on the EPM Dashboard to the user on the user's electronic device 104. In the exemplary embodiment depicted in FIG. 26, the question is associated with the natural threats 2606 category, namely tropical diseases. As used herein, the term “question” is defined as a sentence or statement worded or expressed so as to elicit information in response. In the exemplary embodiment, the statement presented is “infectious tropical diseases such as the dengue fever virus are common in your area,” which is grammatically not a question, per se, but nevertheless expressed in order to elicit a response or answer. In another embodiment, the question may be posed as a grammatical question, such as, “are infectious tropical diseases common in your area?” or “what types of infectious tropical diseases are common in your area?” In one embodiment, the server system 106 may provide, to the electronic device 104 of the user, at least one question that is based on an answer/response to a previous question. For example, an answer of “yes” by the user to the question “are infectious tropical diseases common in your area?” may prompt the next question, which may be “dengue fever virus is common in your area.” Accordingly, in this embodiment, the complete set of questions posed to the user may be at least partially based on the user's answers. This may provide a more user-tailored, adaptive self-assessment. In one embodiment, one or more buttons 2618, or other user-selectable computer-displayable web elements, may be provided with the question to allow the user to transition to the next question or a previous question. FIGS. 27-28 display additional exemplary questions corresponding to the natural threats 2606 category.

In one embodiment, the question may be provided with a set of predetermined answers from which the user may select. In another embodiment, the question may be an open-ended question in which the user forms and provides his/her own answer. As used herein, the term “answer” is defined as a response corresponding to a question or a statement posed to elicit a response. In the exemplary embodiment, the set of pre-determined answers is formed as a five-point agree-disagree scale 2616, where a user selection of the point 2620 closest to the term “strongly disagree” indicates that the user strongly disagrees with the statement/question and a user selection of the point 2622 closest to the term “strongly agree” indicates that the user strongly agrees with the statement/question. User selection of points in between may indicate lesser degrees of agreement and disagreement. Selection of the middle point may indicate a neutral response, where the user can be said to neither disagree nor agree. In yet another embodiment, the agree-disagree scale 2616 may include more or less than five points. Importantly, at least a portion of the pre-determined answers may be weighted differently from one another. These weighted answers may be used by the server system 106 to rank potential threats, hazards, and/or vulnerabilities associated with the user. In another embodiment, the set of predetermined answers may be provided in the form of a checkbox, icon, hyperlink, or other user selectable computer-displayable element. The user may select the answer by, for example, clicking on or otherwise selecting the corresponding answer using a user input interface (mouse, stylus, touchscreen, keyboard, etc.) communicatively coupled to the user's electronic device 104.

In step 314, the server system 106 receives the user-inputted answer to the question from the electronic device 104 over the network 100. The answer is associated with the user-identified account and corresponds to the question, which concerns at least one of a potential threat, a potential hazard, and a potential vulnerability associated with the user. The server system 106 stores the user-inputted answer on a database communicatively coupled with the server system 106 and associates the user-inputted answer with the user's account. The server system 106 may further associate the user-inputted answer with a specific location corresponding to the user, such as a particular school campus, so that the generated assessment matrix and emergency management plan can be tailored to the specific campus location.

In step 316, the server system 106 assigns a weighted value to the user-inputted answer. In the exemplary embodiment, each answer from the set of pre-determined answers is weighted with a value of 1 to 5. An answer of strongly disagree may be weighted with a value of 1, which may indicate a low threat ranking. An answer of strongly agree may be weighted with a value of 5, which may indicate a high threat ranking. An answer of agree, which may be selected by selecting the second closest point from the term “strongly agree” on the EPM Dashboard, may be assigned a weighted value of 4. An answer of disagree, which may be selected by the user selecting the second closest point from the term “strongly disagree,” may be assigned a weighted value of 2. The middle point may be assigned a weighted value of 3, indicating a neutral or middle threat ranking value. In alternative embodiments, the agree-disagree scale may include more or less than five points. Accordingly, the weighted values may be more or less than the range of 1-5. For example, the weighted values may be 1-10 in one embodiment, or 1-3 in another embodiment. In a further embodiment, the weighted values may not be whole number, e.g., fractional values. In yet a further embodiment, the weighted values may include zero or negative values. In yet a further embodiment, some answers in the set of pre-determined answers may be assigned the same weighted value, while other answers in the set may be assigned different weighted values. In an embodiment, where the answers are formed by the user, as opposed to being predetermined by the EPM Dashboard, the server system 106 may include computer instructions that are able to interpret and analyze the answers and assign weighted values to the user formed answers. For example, where the question is an open-ended question, such as “how many burglaries or thefts have occurred on campus with the past year?,” the server system 106 may be able to interpret the user-inputted answer as a numeric value and assign a weighted value based on the number of burglaries or thefts that occurred on campus within the past year. The server system 106 may, for example, compare the number of burglaries/thefts input by the user to the average burglaries/thefts for school campuses and produce a relative weighted value according to the deviation from the average in the area, or nationally. Other algorithms can be used to assign a weighted value to user-inputted answers. What is important is that each answer is assigned a weighted value so that potential threats, hazards, and vulnerabilities can be provided to the user as ranked relative to one another. This can provide valuable information to the user, such as how best to efficiently focus training time and other emergency management planning resources.

In step 318, the process determines whether the weighted value assigned to the answer exceeds a predetermined threshold value. In the exemplary embodiment, the predetermined threshold value is 1. In another embodiment, the predetermined threshold value may be a value more than or less than 1. In yet another embodiment, the predetermined threshold value is a non-zero threshold value. In a further embodiment, the predetermined threshold value may be a positive non-zero threshold value. The predetermined threshold value may be considered a value corresponding to a threat ranking that warrants an additional action, such as preparing a response protocol. In an embodiment where the threat ranking is zero or another relatively low value, additional action, such as preparing a response protocol, may not be required. If the answer is “no,” indicating that the weighted value does not exceed the predetermined threshold, the process proceeds to step 320. If the answer is “yes,” indicating that the weighted value does exceed the predetermined threshold, the process proceeds to step 319, where the server system 106 provides a response protocol.

In one embodiment, the server system 106 provides a drop down menu 2900 of a plurality of response protocols to allow the user to select one response protocol to be associated with a threat, hazard, or vulnerability. The plurality of response protocols provided in the drop down menu 2900 can be associated with response protocols in a response protocol section, discussed herein below. In another embodiment, the plurality of response protocols can be presented to the user in another user-selectable computer-displayable feature, such as, for example, a plurality of hyperlinks, icons, buttons, and the like. Each of the plurality of response protocols may correspond to an action to be taken by the user in response to a potential threat, a potential hazard, and a potential vulnerability of the user. The server system 106 may provide a set of default response protocols that may populate the drop down menu 2900 during the set-up process. The server system 106 may store these default response protocols on the database communicatively coupled to the server system 106, even prior to the user being guided to the response protocol section by the set-up wizard. In some embodiments, users can create their own response protocols in the response protocol section. In one embodiment, users can be prompted to create their own threat scenario questions 3000 that may be tailored to user-specific threat/vulnerability conditions. These user-created threat scenarios can be added to the assessment matrix. The user may select one of the plurality of response protocols using the electronic device 104 of the user. As a result of this selection, the user's selection may be received by the server system 106 communicatively coupled to the electronic device 104 over the network 100. The server system 106 may then store the user's selection, associate the selection with the corresponding question, and use this information to generate the assessment matrix.

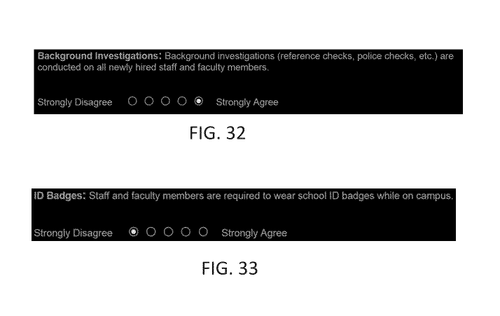

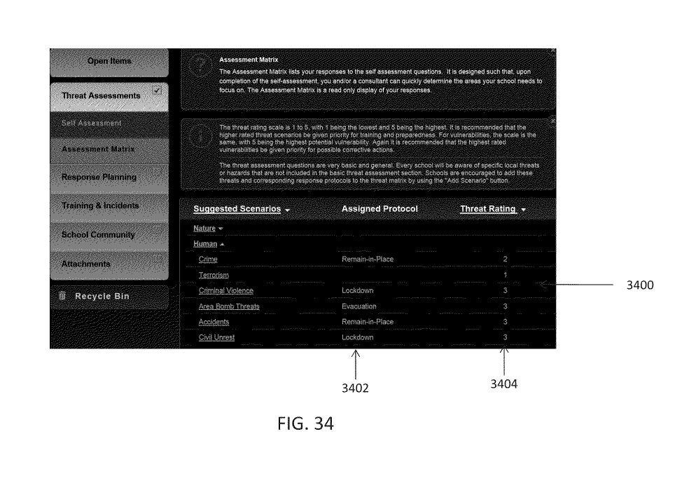

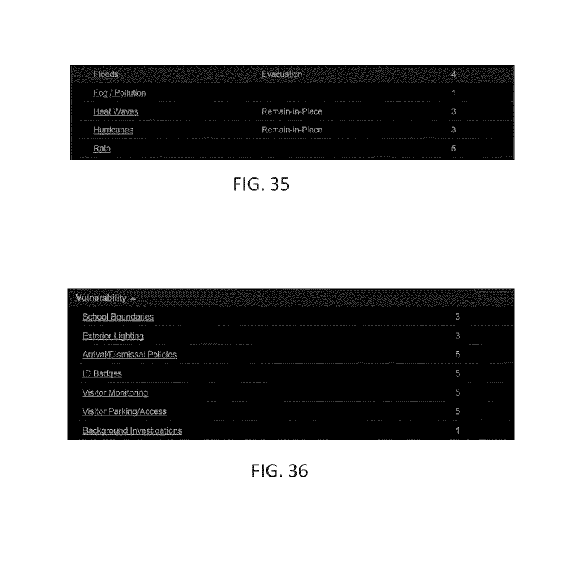

In one embodiment, the self-assessment may include a vulnerabilities section 3100. User-inputted answers in the vulnerabilities section 3100 may also feed the assessment matrix. The vulnerabilities section 3100 may include two sub-categories, a vulnerabilities sub-category 3102 and an emergency communications sub-category 3104. The server system 106 may provide a plurality of questions for each sub-category 3102 and 3104. FIGS. 32 and 33 provide exemplary questions associated with the vulnerabilities section. As with the threats and hazards section, user-inputted answers to questions from the vulnerabilities section may be assigned a weighted value by the server system 106. In the exemplary embodiment, an answer of “strongly agree” is assigned a weighted value of 1 and an answer of “strongly disagree” is assigned a weighted value of 5. Weighted values corresponding to the other answer choices may be distributed in a manner similar to the threats and hazards section, as described above. These user-inputted answers may determine the corresponding threat ranking provided in the assessment matrix. In step 320, the process determines whether the plurality of questions in the self-assessment is complete. If the answer is “no,” the process proceeds back to step 312, where the process steps between step 312 and step 319 are repeated, until all the questions are answered. If the answer is “yes,” the process proceeds to step 322, where the EPM Dashboard provides an assessment matrix 3400. In one embodiment, a processor associated with the server system 106 converts the plurality of user-inputted answers into the assessment matrix 3400. The assessment matrix 3400 may rank the each of the potential threats, hazards, and/or vulnerabilities associated with the user and corresponding to at least one of the questions. The assessment matrix 3400 may further associate each potential threat, hazard, and/or vulnerability with one of the plurality of response protocols and a corresponding threat ranking. The threat ranking may be based on the weighted value assigned to the corresponding user-inputted answers. In the exemplary embodiment, the assessment matrix 3400 lists the threats and hazards categories and the vulnerabilities categories. In one embodiment, the assessment matrix 3400 further lists the sub-categories under each parent category in a parent-child configuration. For example, FIG. 34 shows that the assessment matrix 3400 lists the parent, nature and human, categories and corresponding sub-categories or child categories of crime, terrorism, criminal violence, area bomb threats, accidents, and civil unrest threats beneath the parent human category. Corresponding assigned response protocols 3402 may also be listed in the assessment matrix 3400. In another embodiment, the threat ranking 3404, which is based on the user-inputted answers, may be listed in the assessment matrix 3400 across from the corresponding category. The assessment matrix 3400 may be viewable by the user, as well as, a consultant associated with the provider of the server system 106. FIGS. 35 and 36 show exemplary embodiments of additional portions of the assessment matrix 3400 corresponding to threat categories and vulnerabilities, respectively. Advantageously, the assessment matrix 3400 allows the user to determine how threats, hazards, and vulnerabilities are ranked relative to one another for more efficient and strategic planning of trainings, drills, and resource utilization.

In one embodiment, the EPM Dashboard may include a response planning section, where account users may input a majority of the emergency/crisis response planning for their locations. In step 324, the set-up wizard initiates the response planning section. In one embodiment, these may be gauge element items whose input is used to advance the corresponding gauge element toward a high level of preparedness. The response planning section may include a response planning menu 3700 that lists the set-up wizard guided response planning steps, namely, preparing a crisis management team, inputting rally points, creating/editing response protocols, inputting emergency contact information, and identifying emergency equipment.

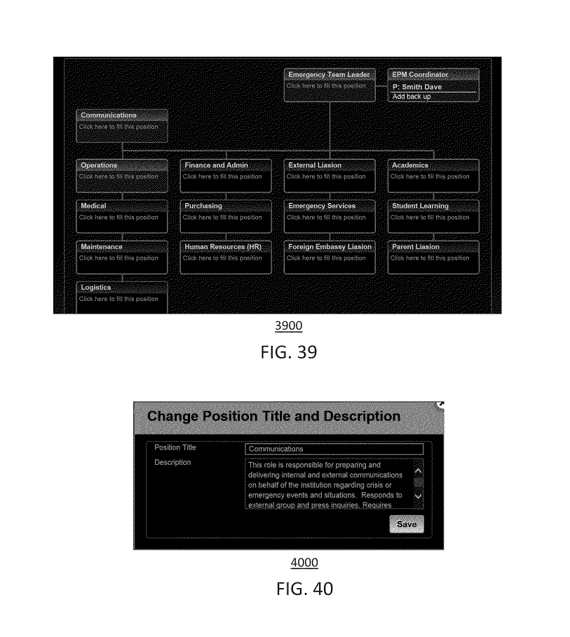

In step 326, the set-up wizard guides the user to a crisis management team section 3800, where the user may be prompted to create and/or assign individuals to a crisis management team 3900. Positions for the crisis management team 3900 may be presented by the EPM Dashboard as a hierarchal block diagram, as depicted in the exemplary embodiment in FIG. 39. Each block in the block diagram may represent a position on the crisis management team 3900. Positions and pre-loaded descriptions of the positions may be editable by the user via, for example, a dialogue box 4000. The user-identified account may be operably configured to be associated with a plurality of users and at least a portion of the users may be assigned to a position or role within the crisis management team associated with the user-identified account. To fill crisis management team positions, the user may be presented with a fill position dialogue box 4100. Account users may utilize names already stored in a community section, discussed below, or may add new names. Community data may be linked to a name lookup feature 4102, where pre-stored names/account users may be associated with a position.

In step 328, the set-up wizard guides the user to a rally points section 4200, where the user may be prompted to input rally point information. A rally point can be considered an area or location that may be within the campus or off-campus where people may assemble safely and be accounted for during or shortly after a crisis or emergency situation arises. In one embodiment, the gauge element associated with the rally points section 4200 may require that a predetermined minimum number of rally points be inputted by the user. In the exemplary embodiment, four rally points must be identified in order for the gauge element 4202 to move from the red to the green section indicating preparedness related to the rally points section 4200. The EPM Dashboard may present a list 4300 of all the rally points input by the user along with an “add rally point” button 4302 that the user can select to be presented with an “add rally point” dialogue box 4400, where the user can input a rally point name, description, and associated attachments, such as a photograph or a map associated with the rally point.

In one embodiment, the set-up wizard may guide the user to a response protocols section 4500, where the user may be prompted to input response protocol information. A response protocol can be considered an action or a set of actions that the user may take as a result of a crisis or emergency. For example, in the event of a fire, the response protocol may be to evacuate all buildings and proceed to a designed external rally point, assemble, and account for all persons. The server system 106 may store a plurality of pre-loaded protocols. The pre-loaded response protocols may include evacuation, reverse evacuation, lockdown, remain-in-place, duck and cover, and off-campus evacuation. The pre-loaded response protocols may populate a quick action guide that outlines each of the response protocols to be used by the user in various emergency situations. In one embodiment, a minimum number of response protocols must be completed by the user before the response protocol gauge element 4502 transitions from a red to a green level of preparedness. In the exemplary embodiment, a minimum number of six response protocols must be completed by the user in order to achieve a full level of preparedness for the gauge element 4502. In another embodiment, each of the pre-loaded response protocols provided by the server system 106 may be editable and changeable by the user via, for example, an edit response protocol dialogue box 4600.

In a further embodiment, the user may add user-created response protocols via, for example, an add protocol dialogue box 4700, where the user can input a protocol name, definition, procedure, associated rally point, and an assigned color (for the quick action guide). Rally points associated with the rally points section may populate a drop down menu of rally points 4800 in the rally points field 4702 of the add protocol dialogue box 4700, so that the user can select from a list of rally points already identified by the user in the rally points section. In addition, the user may select a color code to be associated with each response protocol, in step 332. For example, an assigned color code field 4704 within the add protocol dialogue box 4700 may include a drop down menu 4900, where the user can select a color code to associate with the response protocol for the quick action guide. In one embodiment, a single color may correspond to each selected response protocol such that the quick action guide can associate the selected color with a corresponding response protocol when the quick action guide is physically printed. The physical printed quick action guide may be configured in the form of a “flip book” with colored tabs that allows users to quickly identify a corresponding response protocol. Advantageously, the quick action guide can serve as a handy reference material for key stakeholders that may be responsible for the safety and security of others during a crisis or emergency. In one embodiment, the EPM Dashboard may present the user with a step by step instruction guide 5000 for creating and assembly the physical quick action guide booklet 5100. The server system 106 may store an electronic file of the computer-printable quick action guide depicting the plurality of response protocols so as to be accessible and printable by the user over the network 100 on any electronic device that the user is able to use to login to the user's account.

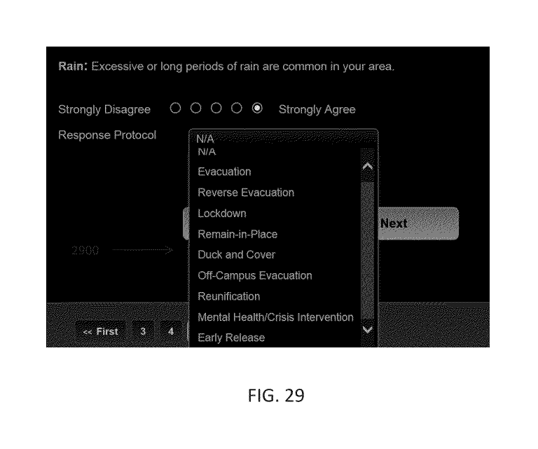

In step 330, as a result of the user inputting a user-created protocol via the add protocol dialogue box 4800, the server system 106 may receive and store the user-created response protocol on a database associated with the server system 106. The server system may associate the user-created response protocol received from the electronic device 104 of the user with a potential threat, hazard, and/or vulnerability. In one embodiment, this association is determined when the user selects a response protocol corresponding to a question from the self-assessment, as depicted with reference to FIG. 29. All the response protocols may be stored with the server system 106, including both the user-created and preloaded response protocols, so as to be accessible by the user over the network 100 on any electronic device that the user is able to use to login to the user's account.

In step 334, the set-up wizard may guide the user to a local resources section 5200, where the user may be prompted to input local resource and emergency contact information. Local resources may be, for example, a local fire department, police department, ambulatory services, bomb squad, hazardous materials unit, mental health unit, poison control center, and other first responders. The EPM Dashboard may present a list of local resources 5200 input by the user and an “add resource” button 5202 that the user may select in order to be presented with an “add resource” dialogue box 5300. In one embodiment, the user may select a local resource in the list of local resources 5200 to be presented with an “edit resource” dialogue box 5400 that may allow the user to edit information associated with the local resource. The emergency contact section may also include an in-school (or on-location) resources section 5500, where users can identify internal resources that may be available during a crisis, such as a school nurse. In-school resources can be selected from names already in the “School Community” sections (staff, administrators, or teachers) or added in this section by, for example, an “add resource” dialogue box 5600.

The response planning section may also include an equipment section, which may include a medical equipment section 5700 and an emergency equipment section 5800. Non-medical equipment would be described in the emergency equipment section 5800. Medical and non-medical equipment may be added with corresponding dialogue boxes.

In step 336, the set-up wizard may guide the user to a training and incidents section, where the user may be prompted to schedule training and drills, record the results of training activities and drills, and record incidents. The training and incidents section may include a training section 5900, where account users may schedule and record training activities (e.g., CPR, software training, safety training), which may not involve students. The training and incidents section may also include a managing training types section 6000, where account users can add training sessions via an “add training” dialogue box 6100. User may log training via a “log training” dialogue box 6200, where users can enter details about completed training activities. In one embodiment, the added training sessions and/or logged trainings may be tied to the school calendar, open items section, and/or activities due section.

In one embodiment, the training and incidents section may include a drills section 6300, where account users may schedule and record drills. Drills may be used to practice the response protocols and are preferably regularly scheduled and involve all or at least a portion of stakeholders practicing their responses to potential threat or hazard scenarios. A managing drill types section 6400 may list drills added via, for example, an “add drill” dialogue box 6500. Account users may also log completed drills via a “log drill” dialogue box 6600.

In one embodiment, users may record incidents or other significant events that occur and may impact safety and security via, for example, an incidents section 6700. By recording these events, account users and EPM consultants can look for patterns of activities that can possibly be mitigated. The incidents section 6700 may also include a search feature 6702 that permits an account user to search their incident database. In another embodiment, the training and incidents section may also include a manage incident type section 6800. The manage incident type section 6800 may allow the account user to document the response to an incident via the identification of an existing response protocol. For example, if an intruder was on campus the manage incident type section 6800 may indicate that a Lockdown response protocol was initiated. If a response to an incident or event required a never-before-used response, then the account user would create a new response protocol, in essence learning from their past incidents. An add incidents section 6900 allows users to add the details of an incident and assign a response protocol. A log incidents section 7000 allows an account user to document an incident or event that has occurred. In addition to entering pertinent and relevant details, photographs and files can be uploaded for retrieval at a later date. In one embodiment, logged incidents cannot be edited or deleted after 24 hours and become a permanent record within the account.

In step 338, the set-up wizard may guide the user to a school community section, where the user may be prompted to list personal identifiers and emergency contact information for immediate stakeholders, such as, for example, students, teachers, staff, and administrators. Each stakeholder may have a dedicated stakeholder section, where each stakeholder may be added in the corresponding stakeholder section (see, as an example of distinct stakeholder sections 7100, 7200, 7300, FIGS. 71-73). In one embodiment, the stakeholder sections 7100, 7200, 7300 may be tied to the crisis management team section, where names from the school community list may be used to add members to the crisis management team.

In one embodiment, the set-up wizard may guide the user to an attachments section, where account users may upload items to the server system 106 to be associated with the account. In another embodiment, the uploaded items may be photographs, videos, reports, and other documents. The attachments section may include a photographs section 7400, where photographs can be uploaded to the server system 106, and another documents section 7500, where other types of documents can be uploaded to the server system 106. The attachments section may include also include an uploaded documents section 7600 that lists uploaded documents that are stored with the server system 106 and associated with the user's account. Each category of uploadable documents may have its own section that includes recommendations on what should be uploaded.

In one embodiment, the attachments section may include a reference library section 7700 that allows users to create, share, and use generic forms that can be shared from other account holders associated with different entities that also possess an account with the server system 106.

In step 340, the user may print a physical copy of an emergency management plan. In one embodiment, the user may be presented with at least two options 7800 for printing a plan. One option may be for account users who want to print the entire plan, which may include everything, or at least a portion, of the information loaded by the user into the Dashboard. The other option may be to print the previously described Quick Action Guide. In one embodiment, the Dashboard may present print and assembly instructions for the user. The process ends at step 342.

A novel and efficient emergency and crisis management tool has been disclosed that providing emergency and crisis plans by effectively utilizing weighted user-inputted data and providing protocols tailored for each individual user for use by the user after an emergency situation arises.

What is claimed is:

1. A computer-implemented method of providing an emergency or crisis plan to a user, the method comprising the steps of:
receiving a plurality of user-inputted answers, from an electronic computing device of a user, at a server system communicatively coupled to the electronic computing device of the user, the plurality of user-inputted answers associated with a user-identified account and corresponding to a plurality of questions concerning at least one of a potential threat, a potential hazard, and a potential vulnerability associated with the user;
assigning, by the server system, a weighted value to each of the plurality of user-inputted answers;
converting, with a processor associated with the server system, the plurality of user-inputted answers into an assessment matrix that ranks the at least one of the potential threat, the potential hazard, and the potential vulnerability associated with the user, the assessment matrix associating the at least one of the potential threat, the potential hazard, and the potential vulnerability with at least one of a plurality of response protocols and a corresponding threat ranking, the threat ranking based on at least one of the weighted values assigned to the each of the plurality of user-inputted answers;
electronically communicating, through the server system, to the electronic computing device of the user, the plurality of response protocols, each of the plurality of response protocols corresponding to an action to be taken by the user in response to the at least one of the potential threat, the potential hazard, and the potential vulnerability of the user; and
electronically communicating, through the server system, to the electronic computing device of the user, a computer-printable quick action guide depicting the at least one of the plurality of response protocols.

2. The computer-implemented method in accordance with claim 1, further comprising:
receiving, from the electronic computing device of the user, at least one user-selected color;
receiving, from the electronic computing device of the user, a selection of one of the plurality of response protocols to be associated with the at least one user-selected color;
associating, with the processor associated with the server system, the at least one user-selected color with the selection of the one of the plurality of response protocols; and
printing the computer-printable quick action guide such that the at least one user-selected color visually corresponds to the selection of the one of the plurality of response protocols depicted in the computer-printable quick action guide.

3. The computer-implemented method in accordance with claim 1, further comprising:
receiving a selection of at least one of the plurality of response protocols, from the electronic computing device of the user, at the server system communicatively coupled to the electronic computing device of the user.

4. The computer-implemented method in accordance with claim 1, further comprising:
providing the plurality of response protocols as a result of the weighted value assigned to at least one of the plurality of user-inputted answers exceeding a predetermined threshold value.

5. The computer-implemented method in accordance with claim 4, wherein:
the predetermined threshold value is a non-zero threshold value.

6. The computer-implemented method in accordance with claim 1, further comprising:
receiving a user-created response protocol, from the electronic computing device of the user, at the server system; and
associating, by the server system, the user-created response protocol received from the electronic computing device of the user with the at least one of the potential threat, the potential hazard and the potential vulnerability.

7. The computer-implemented method in accordance with claim 1, further comprising:
providing, by the server system, to the electronic computing device of the user, at least one of the plurality of questions based on one of the plurality of user-inputted answers to a previous one of the plurality of questions.

8. The computer-implemented method in accordance with claim 1, further comprising:
providing an emergency planning management dashboard associated with the user-identified account, by the server system, to the electronic computing device of the user, the emergency planning management dashboard operable to accept an input from a user input interface communicatively coupled to the electronic computing device of the user, send the input to the server system to be stored on a remote database associated with the server system, and present information in real-time on the electronic computing device of the user based on the input, the information accessible by the user via the electronic computing device of the user as a result of the user logging-in to the user-identified account.

9. The computer-implemented method in accordance with claim 8, wherein:
a gauge is presented on at least a portion of the emergency planning management dashboard, the gauge defining a graphical, computer-displayable visual depiction of a user's emergency planning management preparedness level, the user's emergency planning management preparedness level based on the input to the server system.

10. The computer-implemented method in accordance with claim 1, wherein:
the user-identified account is operably configured to be associated with a plurality of users and at least a portion of the plurality of users are assigned to a role within a crisis management team associated with the user-identified account.

11. A system for providing an emergency or crisis plan to a user, the system comprising:
at least one network connection communicatively coupled to at least one electronic computing device of a user; and
at least one processor communicatively coupled to the at least one network connection, the at least one processor operable to execute a set of computer instructions for:
receiving a plurality of user-inputted answers, over the at least one network connection, from the electronic computing device of the user, the plurality of user-inputted answers associated with a user-identified account and corresponding to a plurality of questions concerning at least one of a potential threat, a potential hazard, and a potential vulnerability associated with the user;
assigning a weighted value to each of the plurality of user-inputted answers;
converting the plurality of user-inputted answers into an assessment matrix that ranks the at least one of the potential threat, the potential hazard, and the potential vulnerability associated with the user, the assessment matrix associating the at least one of the potential threat, the potential hazard, and the potential vulnerability with at least one of the plurality of response protocols and a corresponding threat ranking, the threat ranking based on the weighted value assigned to at least one of the plurality of user-inputted answers;
electronically communicating, over the at least one network connection, to the electronic computing device of the user, a plurality of response protocols, each of the plurality of response protocols corresponding to an action to be taken by the user in response to the at least one of a potential threat, a potential hazard, and a potential vulnerability of the user; and
electronically communicating, through the server system, to the electronic computing device of the user, a computer-printable quick action guide depicting the at least one of the plurality of response protocols.

12. The system in accordance with claim 11, wherein the at least one processor is further operable to execute instructions for:
receiving, from the electronic computing device of the user, at least one user-selected color;
receiving, from the electronic computing device of the user, a selection of one of the plurality of response protocols to be associated with the at least one user-selected color;
associating, with the processor associated with the server system, the at least one user-selected color with the selection of the one of the plurality of response protocols; and
printing the computer-printable quick action guide such that the at least one user-selected color visually corresponds to the selection of the one of the plurality of response protocols depicted in the computer-printable quick action guide.

13. The system in accordance with claim 11, wherein the at least one processor is further operable to execute instructions for:
receiving, over the at least one network connection, from the electronic computing device of the user, a selection of at least one of the plurality of response protocols.

14. The system in accordance with claim 11, wherein the at least one processor is further operable to execute instructions for:
providing the plurality of response protocols as a result of the weighted value assigned to at least one of the plurality of user-inputted answers exceeding a predetermined threshold value.

15. The system in accordance with claim 14, wherein:
the predetermined threshold value is a non-zero threshold value.

16. The system in accordance with claim 11, wherein the at least one processor is further operable to execute instructions for:
receiving, over the at least one network connection, from the electronic computing device of the user, a user-created response protocol; and
associating the user-created response protocol received from the electronic computing device of the user with the at least one of the potential threat, the potential hazard and the potential vulnerability.

17. The system in accordance with claim 11, wherein the at least one processor is further operable to execute instructions for:
providing, over the at least one network connection, to the electronic computing device of the user, at least one of the plurality of questions based on one of the plurality of user-inputted answers to a previous one of the plurality of questions.

18. The system in accordance with claim 11, wherein the at least one processor is further operable to execute instructions for:
providing, over the at least one network connection, to the electronic computing device of the user, an emergency planning management dashboard associated with the user-identified account, the emergency planning management dashboard formed as a computer-displayable user interface operable to accept an input from a user input interface communicatively coupled to the electronic computing device of the user, send the input to a remote database associated with the at least one processor, and present information in real-time on the electronic computing device of the user based on the input, the information accessible by the user via the electronic computing device of the user as a result of the user logging-in to the user-identified account.

19. The system in accordance with claim 18, wherein the at least one processor is further operable to execute instructions for:
providing, over the at least one network connection, to the electronic computing device of the user, a gauge presented on at least a portion of the emergency planning management dashboard, the gauge defining a graphical, computer-displayable visual depiction of a user's emergency planning management preparedness level, the emergency planning management preparedness level based on the input sent to the remote database.

20. The system in accordance with claim 11, wherein the at least one processor is further operable to execute instructions for:
associating the user-identified account with a plurality of users, each of the plurality of users assigned to a role within a crisis management team associated with the user-identified account.
